(19) United States
(12) Patent Application Publication
(10) Pub. No.: US 2026/0191165 A1
(43) Pub. Date: Jul. 9, 2026

(54) Portable Livestock Corral with Integrated Squeeze Chute, Foldable Bud Box, Offset Multi-Axis Panel Hinges, Rear Pen Capability and Panel-Support Shelves

(71) Applicant: Northquip Inc., Woodlands (CA)

(72) Inventor: Stephen Arthur Langrell, Woodlands (CA)

(21) Appl. No.: 19/133,210

(22) PCT Filed: Jan. 24, 2023
(86) PCT No.: PCT/CA2023/050084

§ 371 Date: May 27, 2025

(51) Int. Cl. A01K 3/00; A01K 1/06

(52) U.S. Cl. CPC A01K 3/001; A01K 1/0613

(57) ABSTRACT

A foldable livestock corral, alleyway and a fully functional squeeze chute are combined into a singular transportable unit, with hinged-together fold-out corral panels capable of forming various pen sizes and combinations, and a fold-out bud box for effective routing into the alleyway. The squeeze resides outside the pens for optimal operator safety, with effectively placed man gates for quick access among various strategic operator locations for various cattle handling operations, by one or more operators. Unique multi-axis hinges employed on the corral panels accommodate ground variations while avoiding panel twisting. A unique split door design enables control over livestock flow between alleyway sections, with a non-protrusive design of non-interfering relation to folded stowage of the corral panels. Panel support shelves on opposing sides of the alleyway are raisable against the undersides of the stowed corral panels to confidently bear the weight thereof, for optimal stowage confidence and safety.

### FIELD OF THE INVENTION

The present invention relates generally to portable livestock handling equipment, and more particularly to livestock corrals, squeeze chutes, and alleyways, and combinations thereof, especially in a transportable form.

### BACKGROUND

While there have been different designs of portable livestock corrals in the prior art, the features and reconfigurability thereof to encompass various livestock handling operations and techniques within a singular transportable apparatus have been notably limited, leaving much room for improvements in terms of equipment capacity, equipment capability, and efficiency of use. Applicant has developed a novel design of portable corral with several unique aspects that address such shortcomings of the portable corrals of the past, at least some of which may also be put to beneficial use in the broader context of livestock handing equipment as a whole, whether portable or not.

### SUMMARY OF THE INVENTION

According to a first aspect of the invention, there is provided portable livestock corral apparatus comprising:
a towable frame of elongated character in a longitudinal direction, and having first and second sides of opposing relation to one another in a lateral direction of transverse relation to said longitudinal direction;
first and second sidewall structures of erect relationship to said towable frame at the first and second sides thereof, respectively, and thereby respectively denoting first and second sides of a longitudinally oriented alleyway that is delimited between said first and second sidewall structures and has front and rear ends of opposing relationship to one another in said longitudinal direction;
a first set of corral panels foldable into a stowed condition folded up alongside the first sidewall structure outside the alleyway at the first side thereof, and unfoldable to a deployed state reaching further outward from the first sidewall structure to delimit a first livestock pen at the first side of the alleyway, from which the livestock are admissible to the alleyway through a first livestock entranceway that opens into said alleyway from said first livestock pen; and
a functional livestock squeeze comprising a cooperating pair of first and second squeeze panels operably installed in the first and second sidewall structures at a squeeze section of the alleyway that, in the longitudinal direction of the alleyway, resides between the first livestock entranceway and a livestock exit at the front end of the alleyway.

According to a second aspect of the invention, there is provided a livestock corral apparatus comprising at least one set of corral panels foldable between a stowed condition folded up alongside one another, and a deployed condition unfolded from one another to cooperatively delimit a livestock pen, wherein at least one corral panel among the set of corral panels has a hinged end at which a multi-axis hinge arrangement joins said corral panel to a neighbouring component of the apparatus, and is characterized by an upright swing axis about which the corral panel is swingable side-to-side, and a transverse tilt axis that lies transversely of both the corral panel and the swing axis and about which the corral panel is tiltable up and down.

According to a third aspect of the invention, there is provided a livestock corral apparatus comprising:
an alleyway having first and second erectly standing sidewall structures at opposing first and second sides of the alleyway, respectively;
a first set of corral panels foldable into a stowed condition folded up alongside the first sidewall structure outside the alleyway at the first side thereof, and unfoldable to a deployed state reaching further outward from the first sidewall structure to delimit a first livestock pen outside the alleyway at the first side thereof;
a second set of corral panels foldable into a stowed condition folded up alongside the second sidewall structure outside the alleyway at the second side thereof, and unfoldable to a deployed state reaching further outward from the second sidewall structure to delimit a second livestock pen outside the alleyway at the second side thereof; and
at least one split door installed in the alleyway that is selectively movable between an open state permitting passage of livestock from one section of the alleyway to another, and a closed state preventing said passage, said split gate comprising two door panels that reside side by side to collectively and substantially obstruct the alleyway in said closed state, and that are movable apart from one another to open or increase a gap therebetween through which the livestock can pass in said open state;
wherein a guide track on which said door panels ride during movement thereof between said open and closed states spans between the first and second sidewall structures at areas thereof outside of which the first and second sets of corral panels reside when stowed, and is of substantially non-protruding relation beyond either sidewall structure of the alleyway.

According to a fourth aspect of the invention, there is provided a portable livestock corral apparatus comprising:
a towable frame of elongated character in a longitudinal direction, and having first and second sides of opposing relation to one another in a lateral direction of transverse relation to said longitudinal direction;
at least one set of corral panels foldable into a stowed condition folded up along a respective side of the towable frame, and unfoldable to a deployed state reaching further outward from the respective of the towable frame to delimit a respective livestock pen;
at least one panel-support shelf projecting laterally outward from a respective side of the towable frame at a location that underlies at least a subset of the corral panels when folded up in the stowed condition alongside the towable frame, said panel-support shelf being raiseable and lowerable between a raised position of supportive abutment against undersides of said subset of corral panels, when stowed, to at least partially bear a weight thereof, and a lowered position withdrawn from the undersides of said subset of corral panels.

According to a fifth aspect of the invention, there is provided a portable livestock corral comprising:
a towable frame of elongated character in a longitudinal direction, and having first and second sides of opposing relation to one another in a lateral direction of transverse relation to said longitudinal direction; and
a first set of corral panels foldable into a stowed condition folded up along a respective side of the towable frame, and unfoldable to a deployed state reaching further outward from the respective of the towable frame to delimit a first livestock pen at the first side of said towable frame;
wherein the first set of corral panels are configured for selective deployment thereof in at least two different states of deployment, including a side pen state in which said first set of panels delimit only said first livestock pen at said first side of the alleyway, and a side and rear pen state in which said first set of panels both delimit said first livestock pen and also at least partially delimit a rear livestock pen situated behind the rear end of the towable frame.

According to a sixth aspect of the invention, there is provided a portable livestock corral comprising:
a towable frame of elongated character in a longitudinal direction, said towable frame having two ends of opposing relation to one another in said longitudinal direction, and first and second sides of opposing relation to one another in a lateral direction of transverse relation to said longitudinal direction;
first and second sidewall structures of erect relationship to said towable frame at the first and second sides thereof, respectively, and thereby respectively denoting first and second sides of a longitudinally oriented alleyway delimited between said first and second sidewall structures;
a first livestock entrance in the first sidewall structure, through which livestock are selectively admissible into the alleyway from the first side thereof;
a second livestock entrance in the second sidewall structure, through which livestock are selectively admissible into the alleyway from the second side thereof;
a first set of foldable corral panels deployable externally of the alleyway outside the first sidewall structure thereof to cooperatively delimit a first livestock side pen from which the livestock are admissible to the alleyway through said first livestock entrance;
a second set of foldable corral panels deployable externally of the alleyway outside the second sidewall structure thereof to cooperatively delimit a second livestock side pen residing across the alleyway from said first livestock side pen, and from which the livestock are admissible to the alleyway through said second livestock entrance; and
a set of foldable bud box panels deployable in a first working position outside the alleyway at the first side thereof in a position across from the second livestock entrance to create an enclosed bud box for use in routing of the livestock from the second livestock side pen into the alleyway.

### BRIEF DESCRIPTION OF THE DRAWINGS

Preferred embodiments of the invention will now be described in conjunction with the accompanying drawings in which:

FIG. 1 is a top front left perspective view of a portable livestock corral of the present invention in a transport mode thereof.

FIG. 2 is a top front right perspective view of the portable livestock corral of FIG. 1.

FIG. 3 is a top rear right perspective view of the portable livestock corral of FIG. 1.

FIG. 4 is a top rear left perspective view of the portable livestock corral of FIG. 1.

FIG. 5 is a bottom rear left perspective view of the portable livestock corral of FIG. 1

FIG. 6 is a top rear left perspective view of the portable livestock corral in a deployed field mode defining two full-size livestock side pens on opposing sides of a central alleyway, with a foldable bud box deployed in the left livestock pens.

FIG. 7 is a top front right perspective view of the portable livestock corral of FIG. 6.

FIG. 8 is a partial top front right perspective view of the portable livestock corral of FIG. 6, zoomed in on an entrance section of the alleyway where livestock are admissible from the two livestock side pens.

FIG. 9 is a partial top front left perspective view of the portable livestock corral of FIG. 8, zoomed in the entrance section of the alleyway from the opposing side thereof featuring the foldable bud box.

FIG. 10 is another partial top front left perspective view of the portable livestock corral of FIG. 9, zoomed further in on the foldable bud box.

FIG. 11 is a top perspective view of a multi-axis hinge arrangement between two of the corral panels of the portable livestock corral of FIG. 6.

FIG. 12 is a top perspective view of a similar multi-axis hinge arrangement between one of the corral panels of FIG. 11 and a sidewall structure of the alleyway.

FIG. 13 is a top rear left perspective view of the portable livestock corral in another deployed field mode defining two reduced livestock side pens of smaller size than those of FIGS. 6 and 7, in combination with a full-size rear livestock pen.

FIG. 14 is a top rear left perspective view of the portable livestock corral in another deployed field mode defining one full-size livestock side pen and one reduced livestock side pen, in combination with a reduced rear livestock pen of smaller size than that of FIG. 13.

FIG. 15 is a top rear left perspective view of the portable livestock corral showing a variant of the FIG. 14 field mode in which one panel wall of the rear pen is repositioned to provide increased pen-to-pen access.

FIG. 16 is a top rear left perspective view of the portable livestock corral in a similar field mode to FIG. 6, but illustrating optional relocation of the foldable bud box from one livestock side pen to the other.

FIG. 17 is a top rear right perspective view of the portable livestock corral of FIG. 6, zoomed in on a raiseable/lowerable panel support shelf that would usually reside in a lowered position in field mode, but is shown in a raised position for illustrative purpose.

FIG. 18 is a top rear left perspective view of the portable livestock corral of FIG. 17, zoomed on a matching raiseable/lowerable panel support shelf on the opposing side of the alleyway, in a transitional state of the apparatus during transition from field to transport mode, where the corral panels have been folded up into stowed positions, and a lifting jack is used to raise the panel support shelf up against the undersides to bear a notable weight thereof during transport.

FIG. 19 is an isolated top rear left perspective view of one of two identical split doors installed in the alleyway of the portable livestock corral of the preceding figures.

FIG. 20 is an isolated rear elevational view of the split door of FIG. 19.

FIG. 21A is a partial cross-sectional view of the split door of FIG. 20 as viewed along line A-A thereof.

FIG. 21B is another partial cross-sectional view of the split door of FIG. 20 as viewed along line B-B thereof.

FIG. 21C is a cross-sectional view of the split door of FIG. 20 as viewed along line C-C of FIG. 21B.

### DETAILED DESCRIPTION

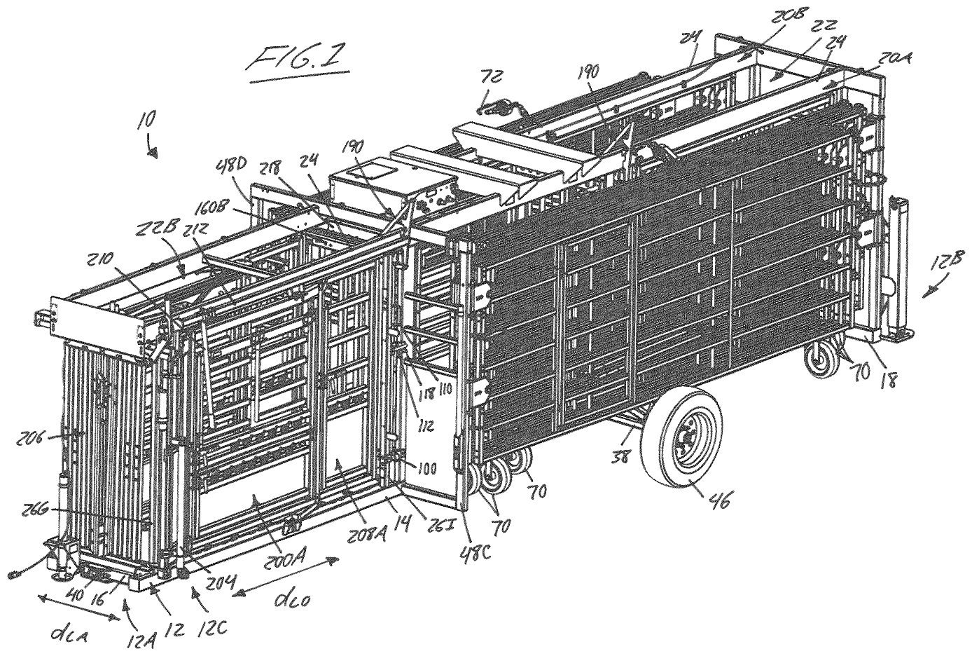

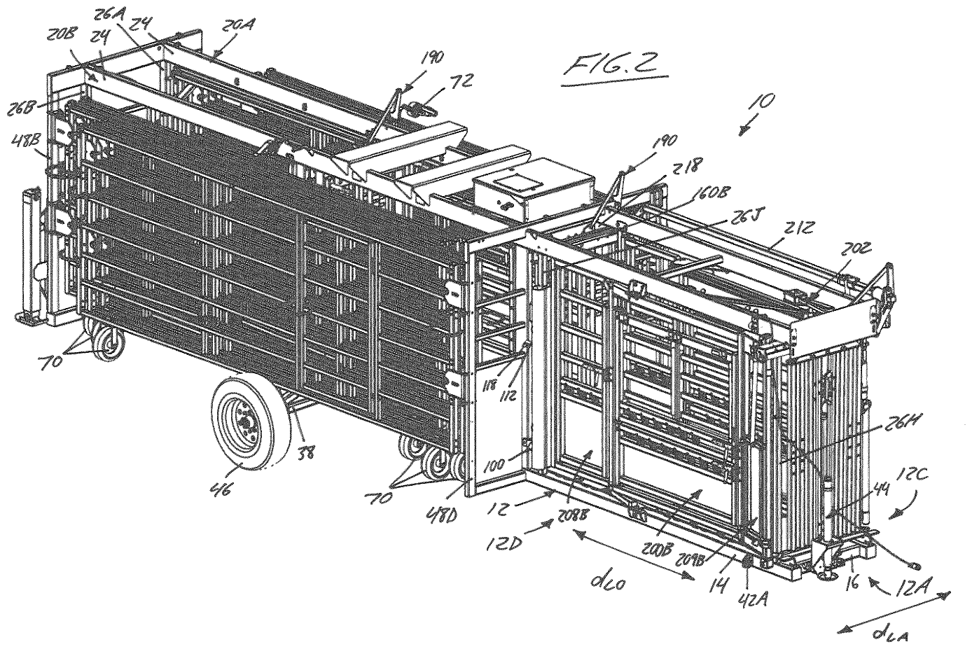

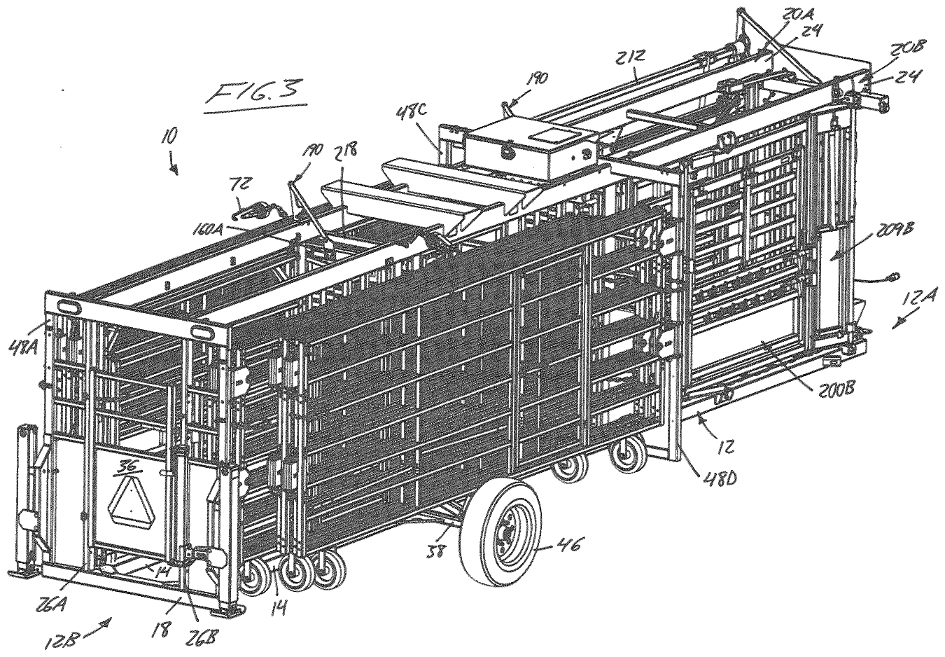

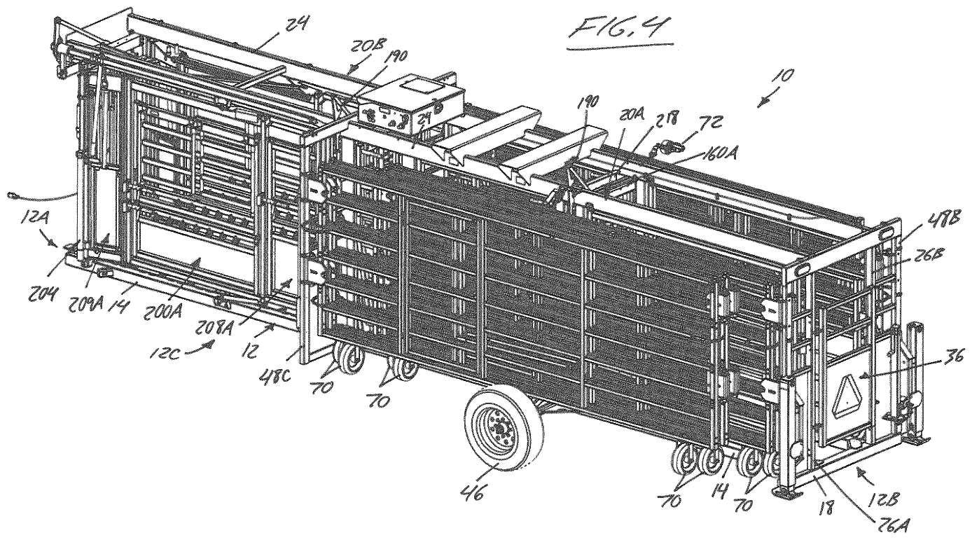

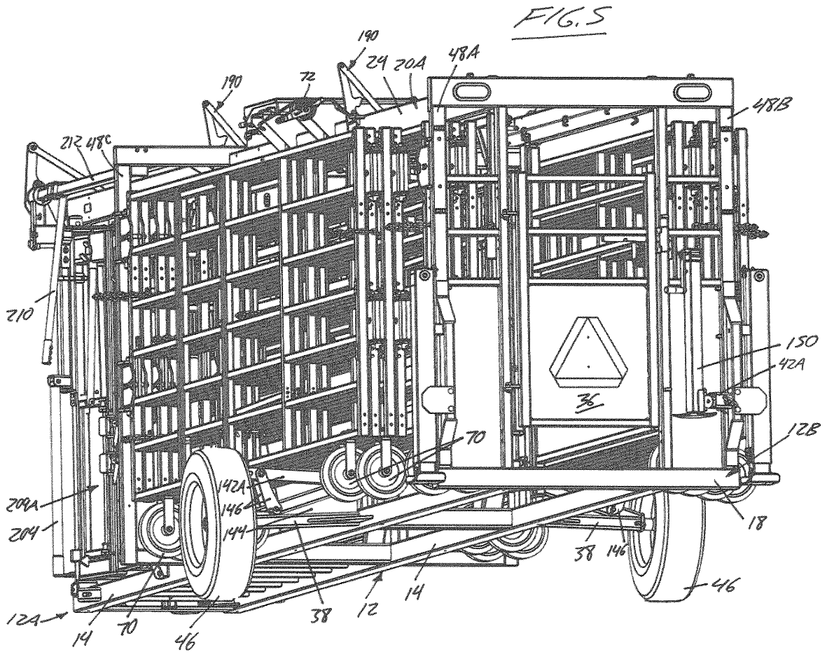

The novel and inventive portable livestock corral 10 shown in the appended drawings has a towable frame 12 of elongated character in a longitudinal direction d_{LO} in which opposing front and rear ends 12A, 12B of the frame are spaced apart in distal relationship to one another. A lateral direction d_{LA} lies perpendicularly transverse of the longitudinal direction d_{LO} in a horizontal reference plane, and the frame 12 has left and right sides 12C, 12D of opposing relation to one another in this lateral direction. FIGS. 1 through 5 show the corral 10 in a collapsed transport mode for towed road travel, while FIGS. 6 through 17 show the corral 10 in expanded working field modes. The frame 12 features two lengthwise beams 14 each running in the longitudinal direction at a respective one of the towable frame's left and right sides, a front cross-beam 16 spanning perpendicularly between the lengthwise beams 14 in the lateral direction at the front end 12A of the frame, and a rear cross-beam 18 spanning perpendicularly between the lengthwise beams 14 in the lateral direction at the rear end 12B of the frame.

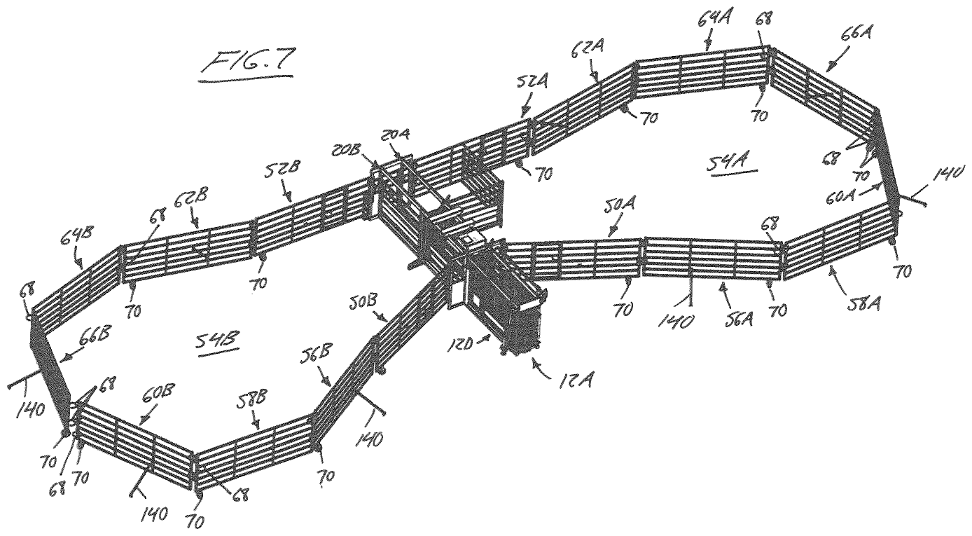

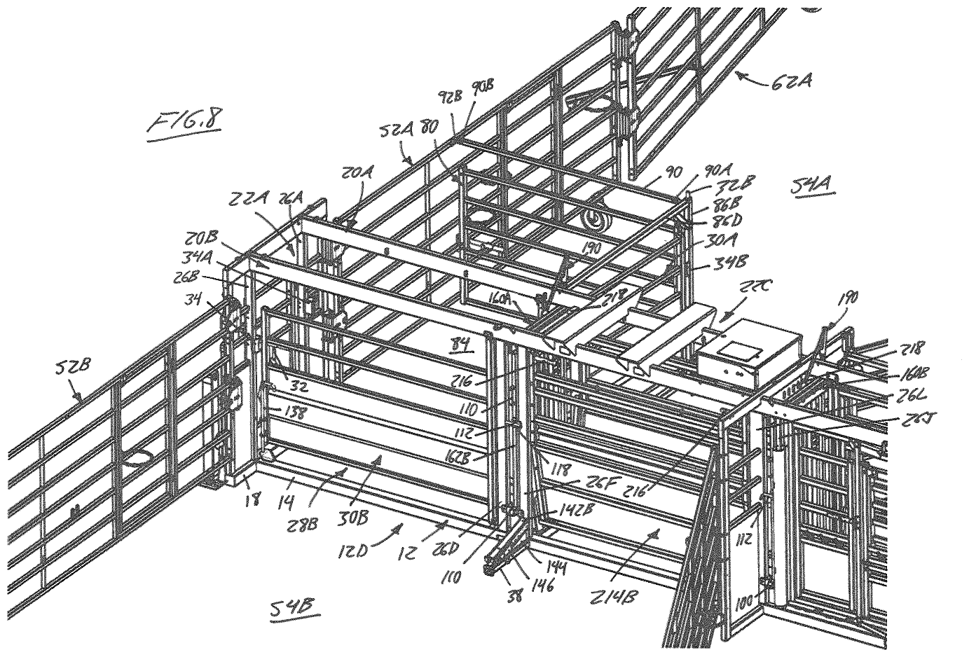

Left and right sidewall structures 20A, 20B of erect relationship to the towable frame 12 reside at the first and second sides 12C, 12D thereof, respectively, and thereby respectively denote first and second sides of a longitudinally oriented alleyway 22 delimited between the two structures 20. Each sidewall structure 20A, 20B features a lengthwise header 24 residing overhead of the respective lengthwise beam 14 of the frame 12 in elevated and aligned relation thereover, and a series of upright frame posts spanning perpendicularly between the lengthwise frame beam 14 and header 24 at longitudinally spaced intervals therealong between the front and rear ends of the frame 12. Of these frame posts a rear frame post 26A, 26B of each sidewall structure 20A, 20B resides at or nearest the rear end 12B of the frame 12, and a rear-adjacent frame post 26C, 26D of each sidewall structure 20A, 20B resides next closest to the rear end of the frame 12, as perhaps best shown in FIGS. 8 and 9.

The area horizontally delimited between each neighbouring pair of frame posts and vertically delimited between the lengthwise frame beam 14 and respective overlying header 24 in each sidewall structure 20A, 20B denotes a respective sidewall area of the alleyway 22 in which a respective sidewall section is installed to define a lateral boundary of a respective segment of the alleyway. In each sidewall structure 20A, 20B, the rearmost sidewall area between the rear frame post 26A, 26B and the neighbouring rear-adjacent frame post 26C, 26D denotes a respective livestock entrance 28A, 28B through which livestock are admissible into the alleyway 22 from the respective side thereof.

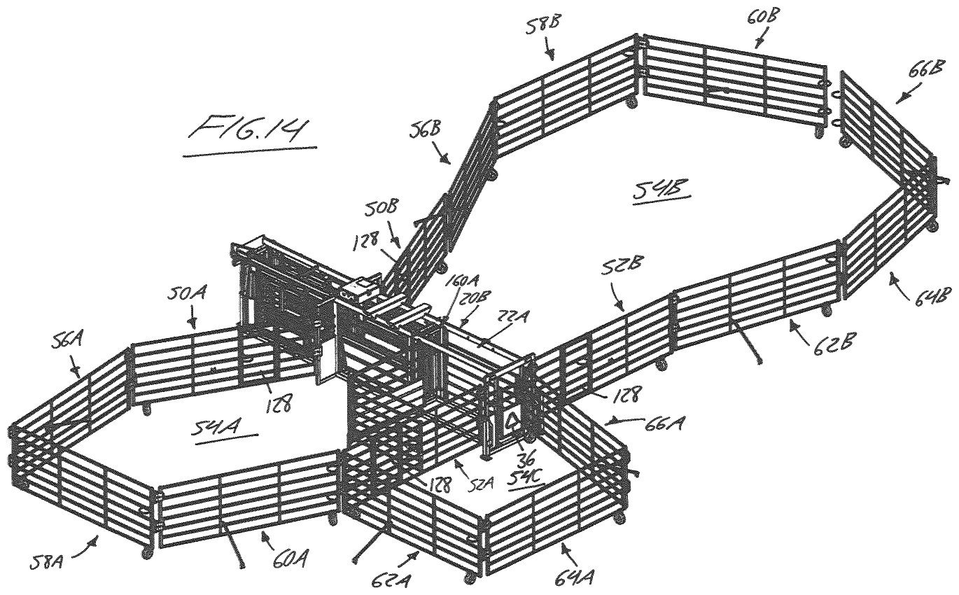

In the illustrated embodiment, with the exception of FIG. 16, the right livestock entrance 28B contains a movable alleyway side-gate 30B hinged to the respective sidewall structure 20B at or adjacent the rear-adjacent frame post 26D for swingable movement relative thereto about an upright hinge axis. This alleyway side-gate 30B is movable about this axis into and out of a closed position occupying, and thus closing, the respective livestock entrance 28B, thereby closing off livestock access to a rearmost entrance section 22A of the alleyway 22 that is delimited between the two livestock entrances 28A, 28B. From this closed position, the alleyway side-gate 30B is swingable into at least an out-swung open position spanning laterally out from the respective side of the alleyway 22 in non-obstructing relation to the interior space of the alleyway. The alleyway side-gate 30B may also be swingable into an in-swung open position spanning laterally across the interior space of the alleyway and through the livestock entrance 28A at the opposing left side of the alleyway 22 (at permitted times when the other livestock entrance 28A is also in an open state). The alleyway side-gate 30B has a spring-loaded slam latch 32 at its swingable free end for automatically latched connection to a latch catch 34 on the rearmost frame post 26A in the closed position of the alleyway side-gate 30A, for automatic locking thereof in that closed position. Through selective opening and closing of this side-gate 30B, livestock can be permitted to enter the rearmost entrance section 22A of the alleyway from the respective side thereof (i.e. the left side, in the illustrated but non-limiting example embodiment). Another alleyway side-gate 30A at the other side of the alleyway similarly operable to open and close the respective livestock entrance 28A is described herein further below.

At the rear end 12B of the frame 12, the alleyway 22 is terminated by an openable/closeable rear alleyway gate 36 hinged to one of the rearmost frame posts 26B, so that a closed position of this rear alleyway gate 36 occupies and thereby obstructs the space between the two rear frame posts 26A, 26B thereby closing off a rear end of the alleyway at the rear end 12B of the frame 12. The rear alleyway gate 36 is swingable into an open position permitting access into the alleyway 22 at the rear end thereof. As used herein, the term “closed” is used to denote a barrier through which livestock cannot pass, but not necessarily a solidly opaque structure, as demonstrated by the partially skeletal form of the illustrated rear alleyway gate 36, whose upper half is composed of a set of vertically spaced horizontal bars with open space between them, but whose lower half is cladded with solid and opaque panel.

FIGS. 1 through 5 show the portable livestock corral 10 in a transport mode, where a pair of removable transport wheels 46 are respectively mounted to the opposing sides 12C, 12D of the frame 12 thereof by a set of stub axles 38 respectively projecting laterally outward from the longitudinal beams 14 of the frame 12 at positions just in front of the rearmost entrance section 22A of the alleyway. Located as such, the stub axles 38, and transport wheels 46, when installed, reside nearer to the rear end 12B of the alleyway 22 and frame 12 than to the front end 12A thereof, yet are out of the way of the livestock entrances 28A, 28B at the rearmost entrance section 22A. Beyond carrying the removable transport wheels 46, these stub axles 38 also serve an additional purpose, explanation of which is given herein further below. At the front end of the frame 12, a tongue receiver 40 is affixed to the front cross-beam 16 at a frontside thereof for selective removable receipt of a pull-tongue (not shown) therein, by which the towable frame 12 can be coupled to the hitch of a tow vehicle (not shown). The transport wheels 46, when installed, cooperate with a towing vehicle to support frame 12 in an elevated state off the ground for rolling transport thereover. Owing to the front-end placement of the tongue receiver 40, the illustrated embodiment is therefore towed from the front end 12A of the frame 12, hence the placement of the transport wheels 46 nearer to the rear end of the frame, though in other embodiments, the apparatus may alternatively be configured for towing thereof from the rear end 12B of the frame 12. Next to the tongue receiver 40, the frontside of the front cross beam 16 also features a jack receiver 42 for selective mounting thereto of a lifting jack 44 by which the front end 12A of the frame 12 can be lifted and lowered during transition of the apparatus between transport and field modes. The lifting jack 44, which may be a hydraulically or otherwise powered jack 44, is shown mounted to the jack receiver 42 in the transport views of FIGS. 1 through 5. FIG. 6 onward instead show the portable livestock corral 10 in working field modes with the transport wheels 46 removed, and the frame 12 seated atop the ground. In these field mode views, the lifting jack 44 is instead mounted to an alternative jack receiver 42A that is instead mounted on the outside of one of the frame's longitudinal beams 14 near, but offset to one side from, the front end 12A of the frame 12, so as not to obstruct exit of livestock from a gated front end of the alleyway 22 at this front end 12A of the frame. As the front ends of the frame 12 and alleyway 22 are coincident with one another, as are the rear ends thereof, the term front end 12A and rear end 12B are used to interchangeably describe those of both the frame 12 and the alleyway 22.

First and second (or left and right) sets of corral panels respectively reside on the opposing sides of the alleyway 22. In FIGS. 1 through 5, the corral panels of each set are shown in stowed transport positions folded up alongside the respective sidewall structure 20A, 20B at the respective side of the alleyway 22. In FIG. 6 onward, the corral panels of each set are shown in deployed working positions cooperating with the respective sidewall structure 20A, 20B to collectively delimit a respective livestock side pen outside the alleyway 22 at an exterior of the respective sidewall structure 20A, 20B. When both sets of corral panels are so deployed, first and second livestock side pens 54A, 54B thus reside across the alleyway 22 from one another, whereby the alleyway 22 denotes a central hub of the overall livestock corral 10 in these deployed field modes. In the illustrated embodiment, each set of corral panels is composed of eight such panels, though the quantity may vary. Each set includes a front corral panel 50A, 50B hinged to the alleyway 22 nearer to the front end 12A of the alleyway than a respective rear corral panel 52A, 52B of the same set, which is instead hinged to the alleyway 22 at a location nearer to the rear end 12B of the alleyway than to the opposing front end 12A thereof. In the illustrated embodiment, the rear corral panel 52A, 52B of each set in the illustrated embodiment is hinged to the alleyway 22 right at the rear end 12B thereof, and more particularly to an offset support post 48A, 48B that stands upright from the rear cross-beam 18 at a respective outer end thereof, at a short distance offset laterally outward from the respective rear frame post 26A, 26B.

By contrast, the front corral panel 50A, 50B of each set is not hinged to the alleyway at the terminal front end 12A thereof, specifically because a frontmost section 22B of the alleyway 22 embodies a functional squeeze chute therein, and is therefore also referred herein as the squeeze section 22B, which is intentionally positioned in a manner that resides entirely outside both livestock side pens 54A, 54B, when deployed. This way, a human operator of the squeeze section 22B will not reside in the same confined space as any penned livestock, thereby ensuring optimal operator safety during functional use of the squeeze section 22B. The front corral panels 50A, 50B of the two sets are therefore hinged to the alleyway 22 at a location denoting the rear end of the squeeze section 22B, which coincides with a front end of a final intermediate section 22C of the alleyway, through which livestock can traverse from the rearmost entrance section 22A in order to reach the frontmost squeeze section 22B. The hinged connections of front corral panels 50A, 50B to the alleyway 22 therefore reside at an intermediate location along the length of the alleyway 22, rather than at a terminal end thereof like the rear corral panels 52A, 52B, and more specifically reside at a location between the side livestock entrances 28A, 28B and the frontmost squeeze section 22B of the alleyway. Similar to the rear corral panels 52A, 52B, the front corral panels 50A, 50B are hinged to a pair of offset support posts 48C, 48D that are each offset outwardly from the plane of the respective sidewall structure's beams 14, headers 24 and frame posts, but this front pair of offset support posts 48C, 48D are offset further outwardly therefrom than the rear pair 48A, 48B of offset support posts. The reason for greater lateral offsetting of the front offset support posts 48C, 48D of the sidewall structures 20A, 20B is due to the corral panel folding pattern of the illustrated embodiment, which is described in more detail further below, where a rear subset of the corral panels fold up against the sidewall structure, and a front subset of the corral panels subsequently fold up against the outside of the folded rear subset, though in other embodiments, the folding order of the two subsets and relative offsetting of the front and rear support posts may be reversed.

Each set of corral panels is composed of such front and rear subsets of corral panels. The front subset of corral panels is composed of the front corral panel 50A, 50B; a first mid-front panel 56A, 56B hinged to the front corral panel 50A, 50B at a distal end thereof opposite the front corral panel's hinged connection to the alleyway 22; a second mid-front panel 58A, 58B hinged to the first mid-front panel 56A, 56B at a distal end thereof opposite the first mid-front panel's hinged connection to the front corral panel 50A, 50B; and an end-front panel 60A, 60B hinged to the second mid-front panel 58A, 58B at a distal end thereof opposite the second mid-front panel's hinged connection to the first mid-front panel 56A, 56B. Likewise, the rear subset of corral panels is composed of the rear corral panel 52A, 52B; a first mid-rear panel 62A, 62B hinged to the rear corral panel 52A, 52B at a distal end thereof opposite the rear corral panel's hinged connection to the alleyway 22; a second mid-rear panel 64A, 64B hinged to the first mid-rear panel 62A, 62B at a distal end thereof opposite the first mid-rear panel's hinged connection to the rear corral panel 52A, 52B; and an end-rear panel 66A, 66B hinged to the second mid-rear panel 64A, 64B at a distal end thereof opposite the second mid-rear panel's hinged connection to the first mid-rear panel 62A, 62B.

Each hinged connection among each set of corral panels has at least an upright swing axis about which two adjacent corral panels can swing relative to one another side-to-side, or about which a front or rear corral panel can swing side-to-side relative to the respective offset support post 48A, 48B, 48C, 48D of the respective sidewall structure of the alleyway 22. As described in more detail below, a unique multi-axis hinge arrangement may be employed at the hinged support of each corral panel to beneficial effect to compensate for profile variation in the ground terrain and prevent twisting of the panels. In their stowed transport positions, the rear subset of corral panels fold up alongside one another in parallel relationship along the respective sidewall of the alleyway 22, and the front subset of corral panels fold up alongside one another in parallel relationship alongside the folded-up rear subset at the outer side thereof opposite the sidewall structure.

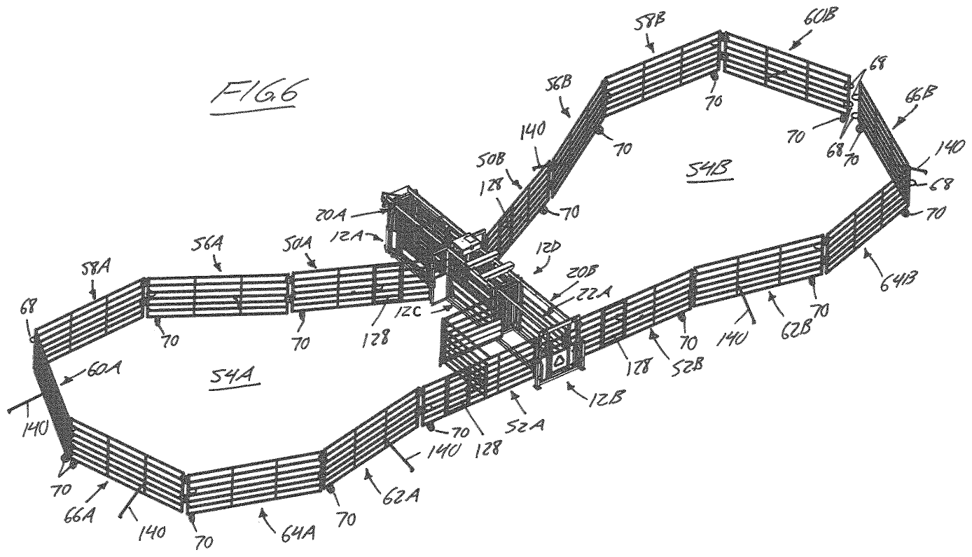

FIGS. 6 and 7 show both sets of corral panels in a full-size side-pen state of deployment, where the size of both livestock side pens 54A, 54B is maximized through use of each set's full quantity of corral panels to solely delimit the respective livestock side pen 54A, 54B. In this full-size side-pen state of each set of corral panels, the front-end panel 60A, 60B from the front subset and the rear-end panel 66A, 66B from the rear subset are secured together at the distal ends thereof opposite their hinged connections to the second mid-front and second mid-rear corral panels, respectively, for example with one or more securement chains 68, or other suitable tether or coupling means. In the illustrated example, each end panel 60A, 60B, 66A, 66B has two such securement chains 68 at the distal end thereof.

Each corral panel has a respective ground wheel 70 on a bottom rail thereof near the distal end of the panel, for rolling support of the corral panel during movement thereof between the stowed and deployed positions. Each ground wheel 70 has its rotation axis lying parallel to the plane of the respective corral panel, so that the rolling direction of the ground wheel is perpendicular thereto, thus correlating to arcuate swinging movement of the distal end of the corral panel about the upright swing axis of its hinged proximal end. In each subset of corral panels, a respective securement chain 68 is provided for use at any point where a distal end of one panel folds up next to a proximal end of another, including at the distal ends of the end panels 60A, 60B, 66A, 66B where the same securement chain(s) referenced above to interconnect the two deployed subsets of corral panels can also be used to secure the end-front panel 60A or end-rear panel 60B to the respective second mid-front panel 62A or second mid-rear panel 62B, when stowed.

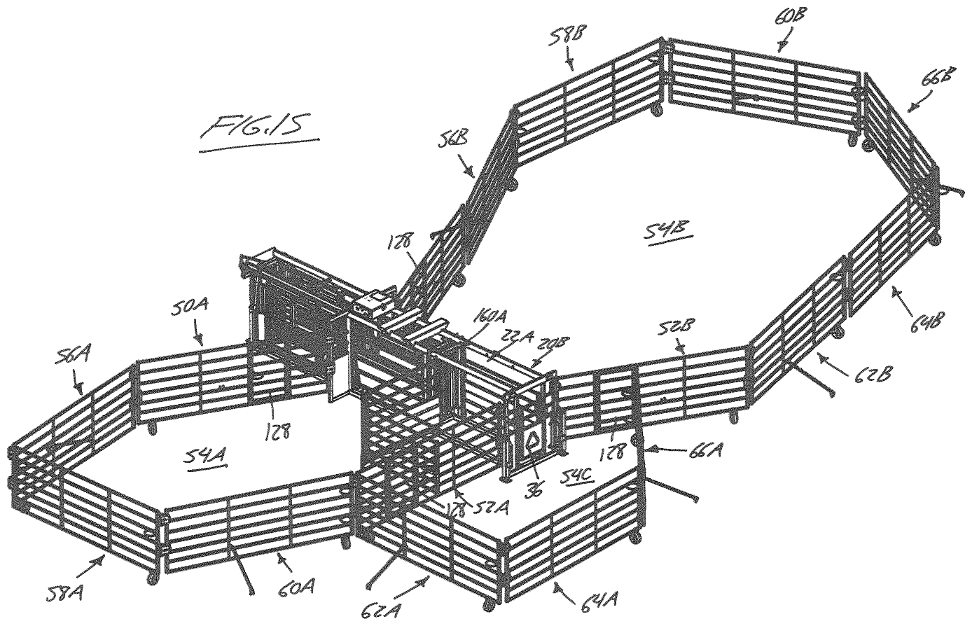

In folding up of the rear subset of each corral panel set to the stowed transport position, the end-rear panel 66A, 66B is folded up along an inner side of the second mid-rear panel 64A, 64B and chained or otherwise secured thereto; the secured-together end-rear and second mid-rear panels are folded up along the outer side of the first mid-rear panel 62A, 62B and chained or otherwise secured thereto; and the secured-together end-rear, second mid-rear and first mid-rear panels are folded up along the inner side of the rear corral panel 52A, 52B. The four secured-together panels of the rear subset are then folded up directly against the sidewall structure 20A, 20B of the alleyway 22 and secured thereto, thereby establishing the stowed transport positions of the rear subset, where the end-rear panels 66A, 66B and first and second mid-rear panels 62A, 62B, 64A, 64B are sandwiched between the respective alleyway sidewalls 20A, 20B and the rear corral panels 52A, 52B. The same folding pattern is followed among the corral panels of the front subset, except that once the four panels of the front subset are folded and secured together, the four panels of the front subset are folded up directly against the outside rear corral panel 52A, 52B of the already stowed rear subset, instead of directly against the alleyway sidewall. Once both subsets are fully folded into their stowed transport positions alongside the alleyway sidewall 20A, 20B, they are secured thereto using a pair of tie-down straps 72 that are anchored to the top headers 24 and bottom frame beams 14 in positions spanning across the outermost one of the folded-up corral panels (the front corral panel 50A, 50B, in the illustrated example) and connecting to anchoring points on the longitudinal beams 14 of the frame 12, and then tensioned to hold the full set of folded corral panels in place against the sidewall of the alleyway 22. FIG. 17 shows such an anchoring point, in the form of a horizontal gusset 73 affixed between stub axle 38 and the respective longitudinal beam 14, with a slot 73A for clipped connection of the strap 72.

To enable improved livestock flow into the alleyway 22 from livestock side pen 54B, the portable corral 10 includes a set of foldable bud box panels, which in the illustrated example incudes a bud box gate panel 80 hinged to a swingable bud box panel 82. The bud box panels 80, 82 are deployable at a rear alleyway-adjacent corner of livestock side pen 54A to form an enclosed bud box 84 next to the rearmost entrance section 22A of the alleyway beside the respective livestock entrance 28A thereof. The drawings, with the exception of FIG. 16, show assembly of the bud box 84 at the rear alleyway-adjacent corner of the first (left) livestock pen 54A for use of the bud box in routing of livestock into the alleyway 22 from the second (right) livestock pen 54B. That being said, the same two bud box panels 80, 82 may alternatively be installed at the rear alleyway-adjacent corner of the second livestock pen 54B for use in routing of livestock into the alleyway 22 from the first livestock pen 54A, as shown in FIG. 16. Also, since the bud box 84 includes an openable/closable gate panel 80, opening of the bud box gate panel 80 in one livestock side pen 54A together with opening of the alleyway side gate 30B in the other livestock side pen 54B allows livestock to be routed from one side pen to the other without uninstalling the bud box. Routing of livestock into the alleyway 22 directly from the livestock pen 54A in which the bud box 84 resides is also possible by opening of the bud box gate 80 while the alleyway side gate 30B of the other livestock side pen 54B is closed, though this loading procedure lacks the benefit of a bud box at the opposing side of the alleyway.

The swingable bud box panel 82 is a gated panel having a rectangular outer panel frame 86 frame composed of a proximal end post 86A, a distal end post 86B, a bottom rail 86C and a top rail 86D. The panel frame 86 is hinged to the first sidewall structure 20A near the front end of rearmost entrance section 22A of the alleyway, for example by pinned connection of the top and bottom ends of the proximal end post 86A to the header 24 and underlying longitudinal beam 14 of the sidewall structure 20A. The outer panel frame 86 is swingable relative to the sidewall structure 20A between a stowed position running alongside the alleyway inside the entrance opening 28A thereof that is bound between the rear frame post 26A and the neighbouring rear-adjacent frame post 26C, and a deployed position spanning laterally outward from the sidewall structure 20A just beside the rear-adjacent frame post 26C at the front end of the livestock entrance 28A. An inner gate of the gated swingable bud box panel 82 serves as the alleyway side gate 30A of matching purpose to the other alleyway side gate 30B at the opposing side of the alleyway, in that it is usable to open and close the respective livestock entrance 28A of the alleyway 22. The alleyway side gate 30A hinged to the swingable bud box panel 82 may therefore be referred to as a bud-mounted alleyway side gate 30A, whereas the other alleyway side gate 30B hinged directly the sidewall structure 20B of the alleyway at the opposing side thereof may be referred to as a wall-mounted alleyway side gate 30B.

As seen in FIG. 9, a hinged end post 88 of the bud-mounted alleyway side gate 30B is hinged to the proximal end post 86A of the outer panel frame 86 of the swingable bud box panel, specifically at a side thereof that faces the rear frame post 26A in the deployed position of the panel frame 86, such that the hinged end post 88 resides in-plane with the longitudinal beam 14 and overlying header 24 of the sidewall structure 20A when the outer panel frame 86 of the swingable bud box panel 82 is in the deployed position. The bud-mounted alleyway side gate 30A is therefore swingable about its upright hinge axis between an alley-closing position occupying, and thereby obstructing, the respective livestock entrance 28A of the alleyway 22, and an alley-opening/bud-boxing position withdrawn from the livestock entrance 28A and instead closing off the space bound by the outer panel frame 86 of the swingable bud box panel 82, and thereby defining a boundary wall of the bud box 84. For locked securement of the bud-mounted alleyway side gate 30A in either position, a latch 32A is provided thereon at a free end thereof that resides opposite its hinged end post 88, and this latch 32A is matable with an alleyway latch catch 34A on the rear frame post 26A of the alleyway sidewall structure 20A in the alley-closing position, and is also matable with a bud box latch catch 34B on the distal end post 86B of the outer frame 86 of the swingable bud box panel 82 in the alley-opening/bud-boxing position.

Whereas the swingable bud box panel 82 is a framed gate panel whose inner gate (bud-mounted alleyway side gate 30A) is surrounded on all four sides by the outer panel frame 86 when latched thereto at latch catch 34B, the bud box gate panel 80 is a frameless gate panel whose hinged end post 81A is hinged directly to the swingable bud box panel 82 at the distal end post 86B thereof, as seen in FIGS. 9 and 10. Opposing distal end post 108 of bud box gate panel 80 is configured for direct latching to the deployed rear corral panel 52A that spans laterally outward from the sidewall structure 20A of the alleyway 22 at the rear end 12A thereof, at a position across the bud box interior from the deployed swingable bud box panel 82, as described in more detail below. Instead of a four-sided outer frame, the bud box gate panel 80 is accompanied by only an overhead joiner bar 90, one end 90A of which is also hinged to the distal end post 86B of the swingable bud box panel 82 for swinging movement relative thereto about an axis parallel to that about which the bud box gate panel 80 swings. The joiner bar 90 is hinged to the distal end post 86B at or near the top end thereof so as to reside at a higher elevation than the bud box gate panel 80. The joiner bar 90 is swingable between a folded position folded up alongside the top rail 86D of the swingable bud box panel 82, where the opposing second end 90B of the joiner bar 90 can be pinned in place to a securement bracket 92A provided on the outer frame 86 of the swingable bud box panel 82 at or near the proximal end post 86A thereof, and an unfolded position spanning outward from the swingable bud box panel 82 to the deployed rear corral panel 52A. The rear corral panel 52A, at a top rail thereof, features another securement bracket 92B to which the second end 90B of the joiner bar 90 can be pinned, and thus locked in this unfolded position. Once so pinned or otherwise secured to the rear corral panel 52A, the joiner bar 90 holds the swingable bud box panel 82 stationary, and thus maintains a squareness of the bud box 84, even when the bud box gate 80 is opened. The use of an overhead joiner bar 90 instead of a full four-sided gate frame at the bud box gate 80 avoids a ground-level bottom rail at this gated outer side of the bud box 84, thus reducing the potential for stumbling or tripping when traversing through this gated outer side when opened.

With reference to FIG. 10, the bud box gate panel 80 employs novel latching mechanism 94 used for selective and releasable coupling of the frameless bud box gate panel 80 to the rear corral panel 52A. The latching mechanism features an L-shaped latch bar 96, a first open-topped latch bracket 98 on the bud box gate panel 80 and a second open-topped latch bracket 100 on the rear corral panel 52A. The first latch bracket 98 is affixed to a horizontal rail 102 of the bud box gate panel 80 at a user-convenient mid elevation thereon. The second latch bracket 100 is affixed to a horizontal rail 104 of the rear corral panel 52A at a slightly greater mid elevation thereon. A longer leg of the latch bar's L-shape denotes a handle portion 96A thereof for manipulation at the hand of a human operator, whereas a shorter leg of the L-shape denotes a latching portion 96B thereof for making latched engagement with the rear corral panel 52A. A support bracket 106 affixed to the upright distal end post 108 of the bud box gate panel 80 rotatably supports an upright hinge pin 110, from which a lateral hinge pin 112 projects out to one side thereof, and penetrates the handle portion 96A of the latch bar 96 via a cross-bore therein. These two hinge pins 110, 112 cooperatively define a multi-axis pivot joint by which the latch bar 96 is manipulatable about two orthogonal axes. The latch bar 96 is thus tiltable up and down about the generally horizontal axis of the lateral hinge pin 112, and, when not constrained by the latch brackets 98, 100, is also swingable side to side about the generally vertical upright axis of the upright hinge pin 110.

FIG. 10 shows the latch bar 96 in its latching position, where the handle portion 96A, at a location thereon between the lateral hinge pin 112 and an operating end 96C of the handle portion 98A opposite the latching portion 96B, lays within the first open-topped latch bracket 98 on the bud box gate panel 80, while the bend of the latch bar 96 on the opposing side of the lateral hinge pin 112 passes through the second open-topped latch bracket 100 on the rear corral panel 52A, and hooks over the outside of the respective rail 104 thereof. Each latch bracket 98, 100 features two upright lugs between which the latch bar 96 is received in this latching position, thus blocking the side-to-side swinging of the latch bar 96 about the upright axis of the upright hinge pin 110.

In this latching position of the latch bar 96, the bud box gate panel 80 is securely latched to the rear corral panel 52A. The weight of the bud box gate panel 80, and any additional downforce that might be exerted thereon during use, acts downwardly on the latch bar 96 at the lateral hinge pin 112, thus encouraging the hooked engagement of the latch bar 96 with the rail 104 of the rear corral panel 52B. Meanwhile, the latch bar 96 is constrained between the lugs of the two latch brackets 98, 100, and thus prevented from swinging about the upright hinge pin 110, which prevents swinging movement of the bud box gate 80 about its hinged connection to the distal end post 86B of the swingable bud box panel 82. To release the latching mechanism 94, a human operator lifts the operating end 96C of the latch bar 96, which initially leverages the bud box gate panel 80 slightly upward, since this action causes the bend of the latch bar 96 to push downwardly on the rail 104 of the rear corral panel 52B. Once the handle portion 96A has been lifted above the lugs of the first bracket 98, the operator then swings the operator end 96C of the latch bar sideways, away from the bud box gate 80, so that the handle portion 96A clears the outer lug of the first latch bracket 98 (the lug thereof furthest from the gate 80). Here, lowering or dropping of the operator end 96C of the latch bar 96 is performed so as to lift the latching portion 96B of the latch bar 96 out of its hooked engagement over the rail 104 of the rear corral panel 52A, and also out from the second latch bracket 100 thereon.

Having performed such unlatching, the bud box gate panel 80 is then freely swingable into a folded position folded up alongside the swingable bud box panel 82, whether for the purpose of temporarily opening up the gated outer side of the bud box (i.e. the side thereof opposite the alleyway entrance 28A), or for the purpose of collapsing and stowing the bud box panels 80, 82 as part of the transition of the portable corral from its working field mode to transport mode. In the case of the latter, both the bud box gate panel 80 and the joiner bar 90 are both stowed in their folded positions alongside the swingable bud box panel 82, which is then swung inwardly about its hinged proximal end post 86A into a stowed position occupying the livestock entrance 28A in the plane of the alleyway sidewall structure 20A. The swingable bud box gate 82 is lockable in this stowed position using another latch 32B, this one being provided on the distal upright end post 86B of the panel's outer frame 86 at the top end thereof, for engagement into a latch hole provided in an underside of the header 24 of the respective sidewall structure 20A just beside the rear frame post 26A thereof.

To help support the swingable bud box panel 82 in its deployed position, a downwardly extendable and upwardly retractable support foot 114 is provided on the distal end post 86B of the panel's outer frame 86. As shown in FIG. 10, the support foot 114 has a slot 116 therein though which it is pinned to the distal end post 86B, which in an unlocked state of the support foot 114, allows upward and downward sliding of the support foot 114 on the distal end post 86B. For locking purposes, the support foot 114 also has multiple locking apertures 118 for selective individual alignment with a locking hole in the distal end post 86B in order to receive a locking pin 120 by which the foot can be fixed at a best suited degree of downward extension for the given ground terrain. After field use, during preparatory transition of the apparatus to transport mode, the support foot 114 can be unlocked by removal of locking pin 120 to allow upward retraction of the support foot 114, followed by reinsertion of the locking pin 120 via a different one of the locking apertures 118 to relock the support foot 114, so that the locked and retracted position thereof does not interfere with stowage of the folded-up bud box panels 80, 82 in the respective livestock entrance 28A of the alleyway 22.

As can be seen in the working field modes of FIGS. 6, 7 and 13 to 16, the front and rear corral panels 50A, 50B, 52A, 52B of each set of corral panels each feature an openable/closable man gate 128 gate therein, at a non-central position along the lengthwise dimension of the corral panel, whereby the man gate 128 of each front or rear corral panel is thus closer to one end thereof than the other. In the preferred embodiment shown in the drawings, only the particular rear corral panel 52A at which the bud box 84 is installed has its man gate 128 positioned further from its alleyway-connected proximal end, and nearer to its opposing distal end, specifically so that the gate panel 80 of the bud box 84 connects to this rear corral panel 52A a location between the rear corral panel's alleyway-connected proximal end and its respective man gate 128, whereby the man gate 128 of this particular rear corral panel 52A resides outside the bud box 84, and provides access to and from the main area of the respective livestock side pen 54A outside the smaller and more confined bud box 84. On the other hand, the other rear corral panel 52B and the two front corral panels 50A, 50B are all installed in a reverse orientation to the bud boxed rear corral panel 52A, such that the respective man gates 128 of these other three alleyway-connected corral panels 50A, 50B, 52B are instead situated closer to their alley-connected proximal ends, and further from their opposing distal ends.

The benefit of this is that a human operator of the squeeze section 22B that resides outside the two livestock side pens 54A, 54B has quick direct access to and from the livestock side pens 54A, 54B via the alleyway adjacent man gates 128 of the front corral panels 50A, 50B, whose close placement to the alleyway 22 also makes it quicker for a human operator to move from one livestock side pen to the other around the front end 12A of the alleyway 22 via these front man gates. The placement of the bud box adjacent man gate 128 of the bud boxed rear corral panel 52A further away from the alleyway 22 is so that the human operator(s) can enter the main area of the respective livestock side pen 54A directly, rather than entering the bud box 84, while the opposing placement of the man gate 128 of the other rear corral panel 52B closer to the alleyway reduces the travel distance from one of these rear man gates to the other, thus reducing travel time from one livestock side pen to the other at the rear end 12B of the alleyway 22.

For manufacturing efficiency, all four gate-equipped corral panels 50A, 50B, 52A, 52B are preferably of identical construction to one another, and have a reversible configuration by which any of these corral panels can be installed in either one of two possible orientations. So, referring to the end of the corral panel nearest to the man gate as a first end of the panel, and the opposing end further from the man gate as a second end of the panel, the first and second ends both have identical mounting features by it can be used for either hinged coupling to the alleyway or hinged coupling to an adjacent panel of the same panel subset, whereby the panels 50A, 50B, 52B are all installed with their first ends serving as the proximal ends hinged to the alleyway, while rear corral panel 52A is flipped 180-degrees relative to the front corral panel 50A of the same set, so as to occupy a reverse orientation with its second end at the proximal position hinged to the alleyway. For brevity, the man gates 128 in the front corral panels 50A, 50B may be referred to herein as front man gates given their location at the front of the livestock pens 54A, 54B, with the man gates in the rear corral panels 52A, 52B similarly referred to as rear man gates.

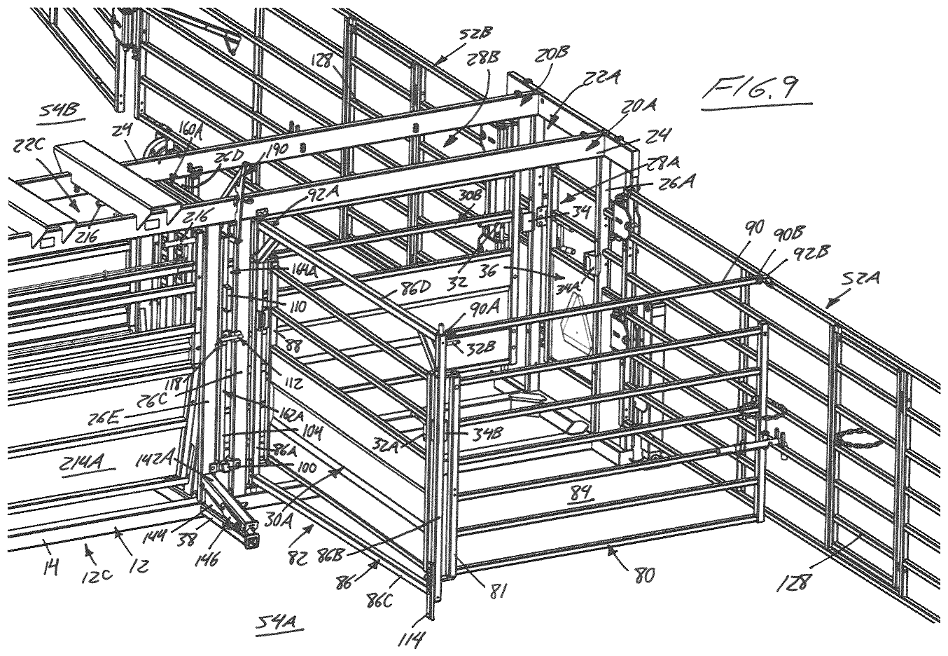

Referring to FIG. 11, attention is now turned to the hinged interconnections between any adjacent pair of corral panels within a given subset. Thes panel interconnections employ a novel multi-axis hinge arrangement by which each panel can not only be swung side-to-side about an upright swing axis, but can also tilt up and down, to a limited degree, about a tilt axis whose orientation is orthogonally transverse to the upright swing axis. FIG. 11 shows the hinged connection between the bud boxed rear corral panel 52A and the adjacent first mid-rear corral panel 62A of the same corral panel subset, but the same hardware is also used at all the other inter-panel connections among each subset. An upright proximal end post 122 of panel 62A passes through a pair of preferably identical channel-shaped post brackets 124A, 124B, each residing at a different elevation along the proximal end post 122. Upper post bracket 124A is pivotally mounted on a respective upright hinge pin 126A, which in turn is carried on a distal end post 128 of adjacent panel 52A by a respective pair of hinge brackets 130A bolted to the distal end post 128 near the top end thereof. Likewise, lower post bracket 124B is pivotally mounted on a respective upright hinge pin 126B, which in turn is also carried on the distal end post 128 of panel 52A by a respective pair of hinge brackets 130B bolted to the distal end post 128 at a lower elevation than the upper pair of hinge brackets 130A.

The upper and lower pairs of hinge brackets 130A, 130B are preferably identical, and place the two upright hinge pins 126A, 126B in alignment with one another on a singular upright axis A_{S}, which defines the aforementioned swing axis of the multi-axis hinge arrangement, whereby the two post brackets 124A, 124B embracing the proximal end post 122 of panel 62A are pinned to panel 52A on this upright swing axis A_{S}. At each inter-panel connection, the upper and lower hinge brackets 130A, 130B project out from the distal end post 128 of the panel to which they are mounted at either an inner side of the panel (i.e. that faces into the livestock side pen 54A, 54B delimited by those panels), or at an opposing outer side thereof, depending on whether the adjacent panel is to fold up along the inner or outer side of the panel carrying the hinge brackets 130A, 13B. In the FIG. 11 example, the hinge brackets 130A, 130B project to the inner side of rear corral panel 52A, to offset the swing axis A_{S} inwardly from the distal end post 128 of the panel 52A, so that the adjacent first mid-rear corral panel 62A can fold up along the inner side of the rear corral panel 52A when being stowed for transport. The hinge brackets 130A, 130B not only offset the swing axis to one side to side to enable folding of the panels flat against one another for stowage, but also offset the swing axis past the distal end post 128 in the length direction of the panel 52A for the cumulative result of a diagonal or compound offset in two directions, which increases an angular range of the allowed swinging movement between the two panels 52A, 62A, up to 270-degrees.

Each post bracket 124A, 124B is penetrated by a respective cross pin 132A, 132B near a distal end of the post bracket furthest from the respective upright hinge pin 126A, 126B, such that the cross pin 132A, 132B resides beyond the proximal end post 122 of panel 62A at a side thereof opposite the distal end post 128 of neighbouring panel 52A The cross pin 132A penetrating the upper post bracket 124A passes through an open space of the panel 62A between the two uppermost rails thereof, while the cross pin 132B penetrating the lower post bracket 124B penetrates an actual physical part of the panel 62A, for example a pivot plate 134 that is welded place between two rails of the panel 62A beside the proximal end post 122 thereof.

The lower cross-pin 132B of the lower post bracket 124B thus serves as a transverse hinge pin lying orthogonally of the upright hinge pins 126A, 126B to define the tilt axis A_{T} about which panel 62A is tiltable up and down relative to panel 52A, while the upper cross-pin 132A of the upper post bracket 124A serves as a stop pin that blocks the proximal end post 122 of panel 62A from escaping the open distal end of upper post bracket 124A, thereby limiting the available degree to which panel 62A can tilt downward relative to panel 52A. The available degree of upward tilt of panel 62A relative to panel 52A is similarly limited by eventual contact of proximal end post 122 of panel 62A with the closed end of the upper post bracket's channel shape. The multi-axis hinge arrangement between adjacent corral panels allows the side-to-side swinging movement needed to fold and unfold the panels, but also allows for upward and downward tilting between the panels to accommodate variation in ground profile and terrain, while preventing twisting of the panels.

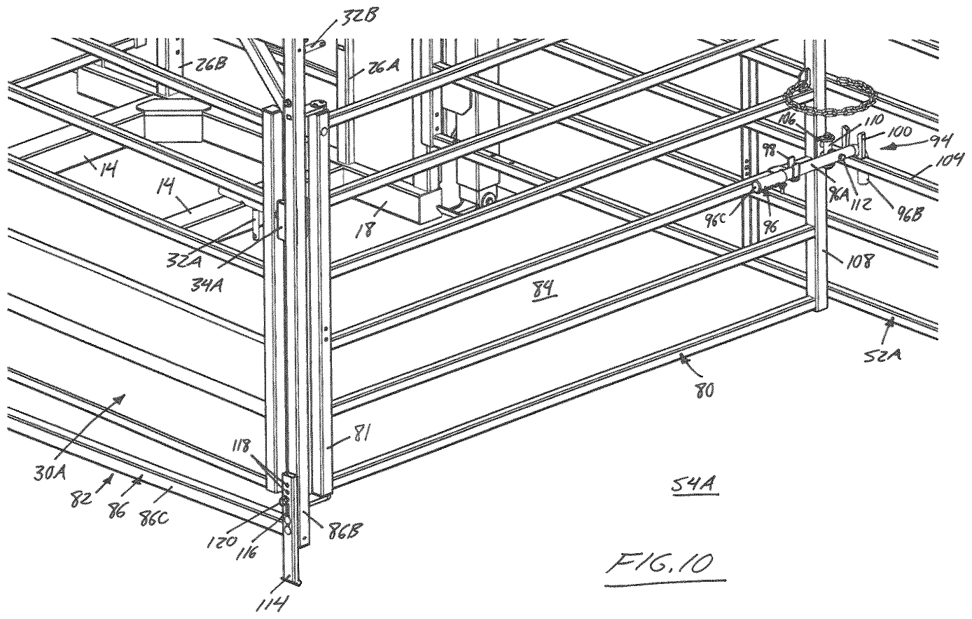

FIG. 12 illustrates hinged connection of panel 52A to the offset support post 48A of the alleyway sidewall structure 20A at the rear end 12B of the alleyway 22, where it can be seen that an identical set of upper and lower post brackets 124A, 124B, upright hinge pins 126A, 126B and cross-pins 132A, 132B are used to support the rear corral panel 52A in the same swingable and tiltable fashion at its proximal end post 122′, with the only difference of the illustrated example being that the hinge brackets 130A′, 130B′ are of a slightly modified shape to fit the offset support post 48A instead of the distal end post 128 of a corral panel. Here is can be seen that the proximal end post 122′ has a set of bolt holes 136 therein of matching relation to the bolt pattern of the hinge brackets 130A, 130B that are installed at the distal end post 128 of the same panel 52A, as per the aforementioned reversibility of the man-gated front and rear panels, which is further supported in FIG. 11 where unused pivot plate 134′ can be seen welded in place beside the distal end post 128 of reversible panel 52A. This way, rear corral panel 52A can be installed in either of two possible orientations of reverse relation to one another, with either end thus being couplable to an neighbouring component of the apparatus, whether that's neighbouring component is a neighbouring corral panel of the same subset, or a sidewall structure 20A, 20B of the alleyway 22.

While FIGS. 6 and 7 show both sets of corral panels in a full-size side-pen state of deployment, where the size of both livestock side pens 54A, 54B is maximized through use of each set's full quantity of corral panels to solely delimit the respective livestock side pen 54A, 54B, one or both sets of corral panels are also capable of other states of deployment providing different pen sizes and pen configurations, all without removal or addition of any corral panels to or from the factory-assembled, foldable corral panel subsets.

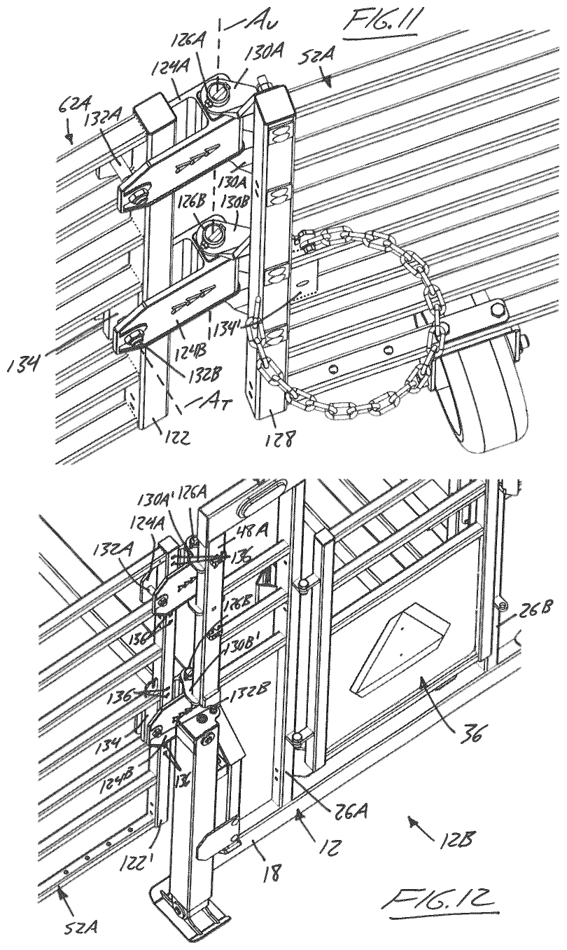

FIG. 13 shows a first side and rear pen deployment state of the two sets of corral panels, where each set of panels once again delimits a respective livestock side pen 54A, 54B situated laterally beside the central alleyway 22 on the respective side thereof, but each side pen 54A, 54B is of a smaller size that that achieved in the full-size side-pen state of FIGS. 6 and 7. In the FIG. 13 deployment state, the size of the side pens 54A, 54B has been partially sacrificed in order to also create an additional rear livestock pen 54C that is situated behind the rear end 12B of the alleyway 22, and is cooperatively delimited by the rear subsets of the two panel sets. Within each deployed set of corral panels, the front subset thereof forms a majority of the respective side pen's boundary wall, starting with the front corral panel 50A, 50B that spans laterally outward from the respective alleyway sidewall structure 20A, 20B at the respective side 12C, 12D of the frame 12 and alleyway 22, for example at a slight forward angle as illustrated; from which the first mid-front panel 56A, 56B continues this lateral outreach from the frame 12 and alleyway 22, for example at slight rearward angle as illustrated; from which the second mid-front panel 58A, 58B then turns more rearward, for example running parallel to the frame 12 and alleyway 22 as illustrated; from which the end-front panel 60A, 60B then turns back inwardly toward the frame 12 and alleyway 22, for example at a slight rearward angle as illustrated.

The distal end of this final front-end panel 60A, 60B of the front subset meets with the distal end of the rear corral panel 52A, 52B from the rear subset of the same panel set, which spans laterally outward from the same side of the frame 12 and alleyway 22 at the rear end thereof, for example in coplanar relationship with both the rear end of the alleyway 22 and the matching rear panel of the other set of corral panels on the opposing side of the frame 12 and alleyway 22. Here, where the front-end panel 60A, 60B of the front subset meets the rear corral panel 52A, 52B from the rear subset, these two meeting panels are secured together using the aforementioned securement chains 68 or other suitable tether or coupling means. From this meeting point, the first mid-rear panel 62A, 62B spans longitudinally rearward from the rear corral panel 52A, 52B, for example in parallel relation to the elongated frame 12 and alleyway 22 in the illustrated example; from which the second mid-rear panel 64A, 64B continues this rearward outreach beyond the rear end of the frame 12 and alleyway 22, for example at a slight inward angle as illustrated; from which the rear-end panel 66A, 66B then turns fully inward, for example in parallel relation to the rear corral panel 52A, 52B as illustrated, so that the distal ends of the two rear-end panels 66A, 66B meet up with one another, for securement together via their securement chains 68 or other suitable tether or coupling means, at a location aligned with the rear end 12B of the alleyway 22 at a rearwardly longitudinal distance therefrom. The result is that the two rear subsets form a large rear pen 54C that is situated behind the frame 12 and alleyway 22, and is separated from each side pen 54A, 54B by the respective rear corral panel 52A, 52B thereof, which doubles as both a rear barrier wall of the side pen and a respective front barrier wall of the additional rear pen 55C on the respective side of the alleyway 22.

Livestock flow between either side pens 54A, 54B and the rear sorting pen 54C is enabled via the rear alleyway gate 36. With alleyway side gate 30B and rear gate 36 both open, cattle can be routed between side pen 54B and rear pen 54C via the rearmost entrance section 22A of the alleyway. With bud box gate panel 80 and rear alleyway gate 36 open, cattle can be routed between side pen 54A and rear pen 54C via the bud box 84 and rearmost entrance section 22A of the alleyway. One or more human operators can traverse between either side pen 54A, 54B and the rear pen 54C via the respective man gate 128 in the respective rear corral panel 52, 52B. Though opening and closing of the alleyway side and rear gates 30B, 36 and the bud box gate panel 80, livestock can be routed from any of the three pens 54A, 54B, 54C up through the alleyway to the squeeze section 22B.

FIG. 14 shows another side and rear deployment state of the two sets of corral panels, once again forming a rear livestock pen 54C behind the frame 12 and alleyway 22, but this time using only the rear subset of one corral panel set to form this rear livestock pen 54C, resulting in a much smaller rear pen size. The side pen 54A formed of the same corral panel set whose rear subset is used to form the rear pen 54C is of the same reduced size shown in FIG. 13, while the other side pen 54B is of the same full size shown in FIGS. 6 and 7, since its full set of corral panels is used solely for formation of the respective side pen 54B, and not toward the formation of the small rear pen 54C. In this configuration, the man gate 128 in the rear corral panel 52B of the larger side pen 54B does not open into the rear pen 54C, but human access between the smaller side pen 54A and rear pen 54C remains available via the man gate 128 of the smaller side pen's rear corral panel 52A, just outside the bud box 84. In this deployment state, the front panel subset of the smaller side pen 54A is deployed in the same fashion as FIG. 13, as are the rear corral panel 52A and first mid-rear panel 62A of the rear subset. The second mid-rear panel 64A, instead of continuing rearward from the first mid-rear panel 62A, turns fully inward like the end-rear panel 66A did in FIG. 13, and in this instance, the end-rear panel 66A at the distal end of the second mid-rear panel 64A turns forwardly therefrom, and connects to the rear end of the alleyway 22 at the sidewall structure 20B on the opposite side of the alleyway 22 from where this rear panel subset originated. That is, the end-rear panel 66A connects to the alleyway 22 at a location across the rear alleyway gate 36 from the rear corral panel 52A of the same subset. This attachment of end-rear panel 66A to the alleyway 22 may occur for example at the rear frame post 26B thereof, or offset rear support post 48B, using the rear-end panel's securement chains 68 or other tether or coupling means.

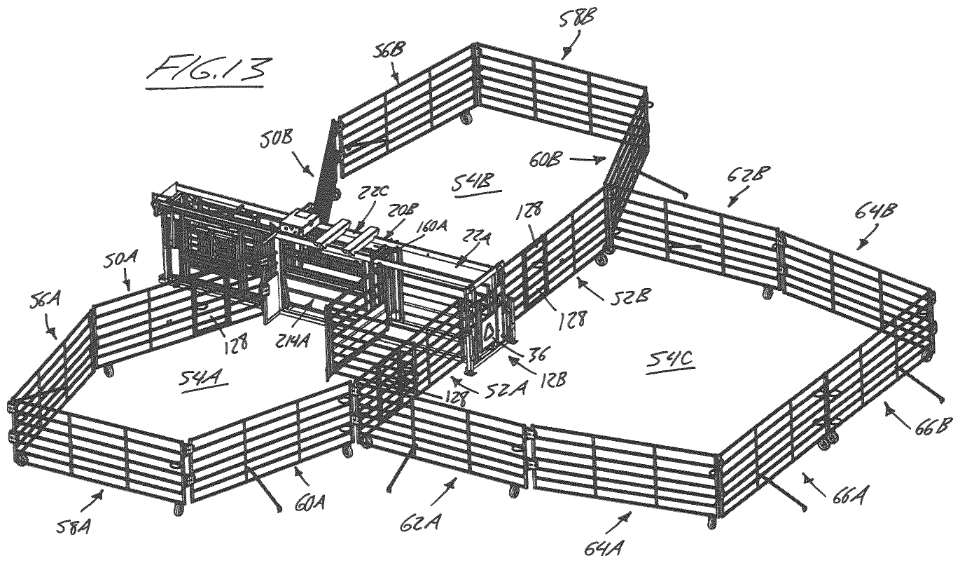

FIG. 15 shows a variant of the side and rear deployment state of FIG. 14, again with a full-size side pen 54B on one side of the alleyway 22, a reduced size side pen 54A on the other side of the alleyway 22, and a reduced size rear pen 54C behind the alleyway 22. The difference in this variant is that instead of being coupled to the sidewall structure 20B of the alleyway 22, the final rear-end panel 66A of the rear subset used to form the small rear pen 54C is coupled to the rear corral panel 52B of the full-size side pen 54B at a position thereon past the respective man gate 128 thereof, for example at or closely beside the frame of the man gate on the far side thereof furthest from the frame 12 and alleyway 12. This way, full human operator access is provided from the full-size side pen 54B to the small rear pen 54C, and onward therefrom into the smaller side pen 54A, and vice versa, as enabled by the two rear man gates.

This variant offers better access for operation by a single human operator, where the operator can start in the large side pen 54B, encourage livestock therefrom into the alleyway entrance section 22A and adjacent bud box 84, close the alleyway side gate 30B behind the admitted livestock, then travel over to the smaller side pen 54A through the rear pen 54C via the rear man gates so that, from the main area of the smaller side pen 54A, they can encourage livestock from the bud box 84 into the alleyway, and onward therethrough to the squeeze section 22B. By comparison, the FIG. 14 deployment is better managed by two operators, one who stays in the large side pen 54B, and the other who, via the front man gate of the smaller side pen 54A, switches between manning of the squeeze section 22B outside the side pen 54A, and manning of the bud box 84 from inside the side pen 54A to encourage the livestock admitted to the bud box 84 from the larger side pen 54B into the alleyway 22 and onward therethrough to the squeeze section 22B.

FIG. 16 illustrates the same full-size side-pen deployment state as FIGS. 6 and 7, but with the bud box panels 80, 82 (and the associated bud-mounted alleyway side gate) moved to the other side of the alleyway, with the wall-mounted alleyway side gate likewise being swapped from one side to the other, whereby the bud box 84 now resides in the right side pen 54B instead of the left side pen 54A. The illustrated embodiment employs a reversible bud box assembly to enable this switching of the bud box between either side of the alleyway using the same equipment. For such purpose, the outer frame 86 of the swingable bud box panel 82 has matching hinge brackets on both the proximal and distal end posts 86A, 86B, either of which can accept hinged mounting of either the bud box gate panel 80 or the bud-mounted alleyway side gate 30A. so to reconfigure the swingable bud box panel 80 for relocation from one side of the alleyway 22 to the other, the bud box gate panel 80 and the bud-mounted alleyway side gate 30A are swapped between these two hinged mounting points at opposite end posts 86A, 86B of the swingable bud box panel's outer frame 86. The latch 32B and support foot 114 of the swingable bud box panel 82 are likewise relocatable from the one end post of the panel's outer frame 86 to the other using predefined mounting points on these posts, and are likewise swapped therebetween as part of the reconfiguration of the bud box assembly for relocation from one side of the alleyway 22 to the other.

As can be seen in FIG. 8, the wall-mounted alleyway side gate 30B panel has a raisable/lowerable ground stake 138 thereon at its latch-equipped swingable free end, at a side thereof that faces outwardly from the alleyway 22 in the wall-mounted side gate's closed position. This ground stake 138 is relocatable from one side of the wall-mounted side gate 30A to the other to reconfigure the side gate for use at the opposing side of the alleyway 22 when location-swapped with the foldable bud box assembly 80, 82, 30B. As shown in the various working field views, at least some the corral panels may have swing-out ground stakes 140 thereon that lie coplanar with their respective corral panels between adjacent rails thereof when stowed, and are deployable into outwardly reaching and downwardly angled working positions engaging the ground outside the pens 54A, 54B, 54C in the working field mode in order brace the panels against movement in the event of animal impact during use.

To help bear the weight of the folded-up corral panels in their stowed positions alongside the alleyway sidewall structures 20, 20B in the transport mode shown in FIGS. 1 through 5, each side 12C, 12D of the frame/alleyway is provided with a respective raisable/lowerable panel support shelf 142A, 142B for bracing an underside of the stowed corral panels. Reference is made to the field mode view of FIG. 17 for a revealing look one of the panel support shelves 142B, where it is unobstructed by transport wheels 46 and the stowed corral panels that block a clear full view thereof in transport mode. The shelf 142A on the opposing side of the alley is of matching construction and function. The shelf 142B itself, in the illustrated but non-limiting example, is embodied by a length metal channel that, an inner end thereof nearest the alleyway 22, is pivotally pinned to the respective sidewall structure 20B thereof at a short elevation above the respective longitudinal beam 14 of the frame. In the illustrated example, the support shelf 142B is pivotally pinned to a triangular gusset 144 that is fixed between the respective stub axle 38 that projects out from the longitudinal beam 14, and one of the frame posts 26E of the sidewall structure that stands upright from the same longitudinal beam 14 at a matching location to the stub axle 38. On the other side of the alleyway 22, the other stub axle 38, gusset 144 and panel support shelf 142A reside at a matching location along the alleyway, at a matching frame post 26F situated across from frame post 26E. The stub axle 38 and attached gusset 144 thus form a shelf base of underlying relation to the pivotally mounted support shelf 142B.

In lowered a position of the support shelf 142B, it rests atop the gusset 144, and thus slopes downwardly away from the sidewall structure 20B of the alleyway. FIG. 17 shows the support shelf 142B in a raised position projecting outwardly from the plane of the sidewall structure in substantially perpendicular orientation relative thereto, thus denoting a horizontal orientation when the portable corral is on flat ground with the sidewall structures standing vertically upright. In the stowed positions of the corral panels, this raised position of the support shelf 142B abuts against the undersides of the stowed panel corrals, as can be seen of matching support shelf 142A in FIG. 5. Lowering of the support shelf 142A from this raised position, as part of the transition from transport mode to working field mode, withdraws the support shelf 142A from the undersides of the stowed corral panels, so as to allow unfolding thereof from their stowed positions without any interference from the lowered support shelf. To hold each support shelf 142A, 142B in its raised position, a mechanical lock is included, that features a pair of locking lugs 146 that are pivotally pinned to the support shelf 142A, 142B at opposing front and rear sides thereof near the outer end thereof furthest from its pivotally pinned inner end. In the raised position, these locking lugs 146 hang down from the raised support shelf 142A, 142B on opposing sides of the gusset 144, where pin apertures in the lugs 146 can be aligned with a pin hole that penetrates through the gusset 144 for receipt of a locking pin 148 collectively therethrough to lock the lugs in place, whereby the locked lugs 146 form supportive struts spanning from the shelf base to the support shelf 142A, 142B to hold the latter its raised position.

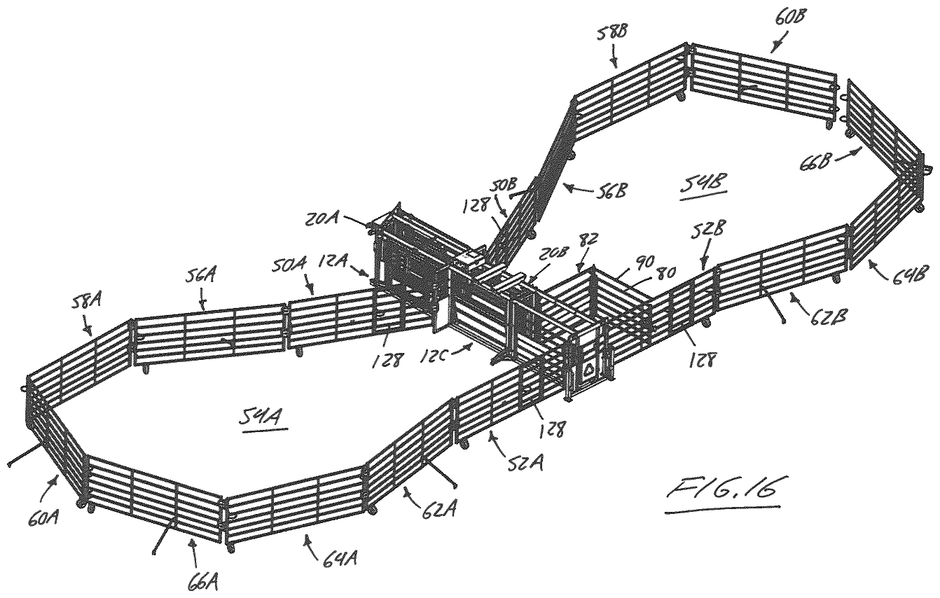

With reference to FIG. 5, a lifting jack 150 is removably stored at the rear end 12B of the alleyway 22 in transport mode, just outside the rear alleyway gate 36 and off to one side thereof, where the lifting jack 150 is removably pinned to another jack receiver 42A. FIG. 18 illustrates this lifting jack 150 in a working position thereof, having been removed for its mounted storage at the rear end jack receiver 42A, and placed into working relation with one of the lowered support shelves 142A just outside the respective set of stowed corral panels. In this working relationship of the lifting jack 150 and support shelf 142A, a raiseable/lowering lifting element of the lifting jack 150 is received through the open end of the channel shaped support shelf 142B and temporarily pinned thereto with a coupling pin 152 inserted through pin holes 154 in the sidewalls of the channel shaped support shelf 142B. This way, upon operation of the lifting jack in a lifting direction, for example by manual rotation of a crank handle 150A of the lifting jack, or engagement and driving of a tool-drivable driveshaft of the crank with a cordless drill or the like, will drive the support shelf 142A upward into its raised position supportively abutting the undersides of the stowed corral panels. In this raised position, the locking pin 148 is then engaged through the locking lugs 146 and the gusset 144 of the shelf base to lock the support shelf 142A in place, whereupon the lifting jack 150 can be unpinned from the support shelf, lowered and returned to the rear jack receiver 42A or other suitably mounted or secured storage location. To later transition from transport mode to field mode, the locking pin 148 is removed, whereupon the support shelf 142A will fall to its lowered position withdrawn from the undersides of the stowed corral panels. The locking pin 148 is reinserted through the locking hole in the gusset 144 for safe keeping, and the unlocked locking lugs 146 lie alongside the support shelf 142A and gusset 144, in resting fashion atop the locking pin 148. During raising of the support shelf 142A, the locking lugs swing downward into their hanging positions lockable to the shelf base.

To control livestock flow through the alleyway 22 from the rearmost entrance section 22A to the frontmost squeeze section 22B, the illustrated embodiment includes two split doors 160A, 160B operable to selectively isolate any adjacent two of the three alleyway sections 22A-22C from one another any time via selective closure of one of said split doors. A first of these split doors 160A, 160B resides at the front end of the alleyway entrance section 22A, which coincides with the rear end of the intermediate alleyway section 22C, and is therefore referred to herein as the rear split door 160A, since it resides nearer to the rear end 12B of the alleyway than the second split door 160B, which is therefore referred to herein as the front split door 160B. This front split door 160B resides at the front end of the intermediate alleyway section 22C, which coincides with the rear end of the squeeze section 22B. The rear split door 160A is therefore operable to selectively allow and prevent livestock traversal from the alleyway entrance section 22A to the intermediate alleyway section 22C via opening and closing, respectively, of this rear split door 160A. Similarly, the front split door 160B is operable to selectively allow and prevent livestock traversal from the intermediate alleyway section 22C to the squeeze section 22B via opening and closing, respectively, of this front split door 160B.

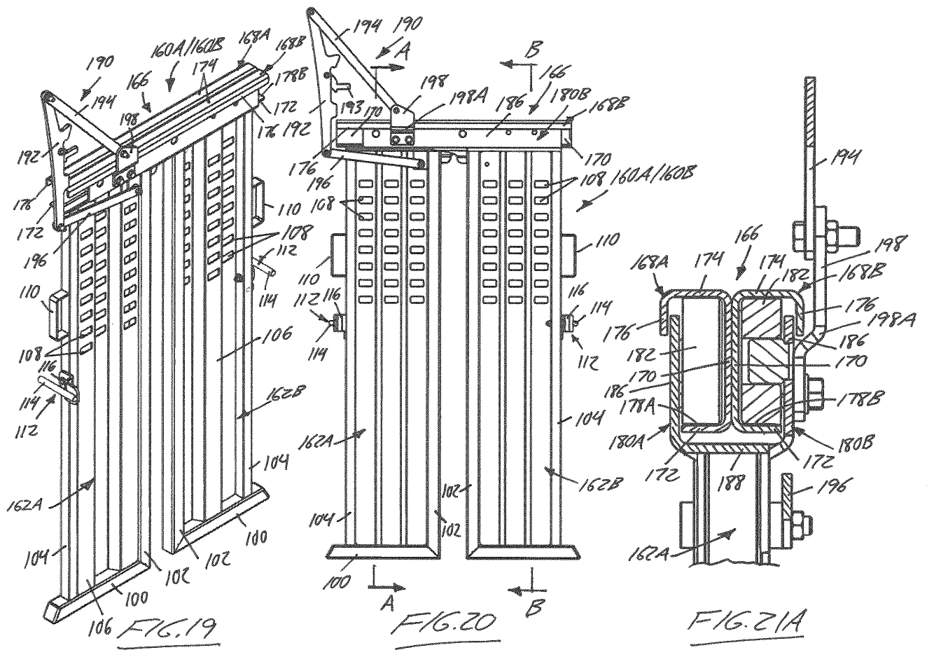

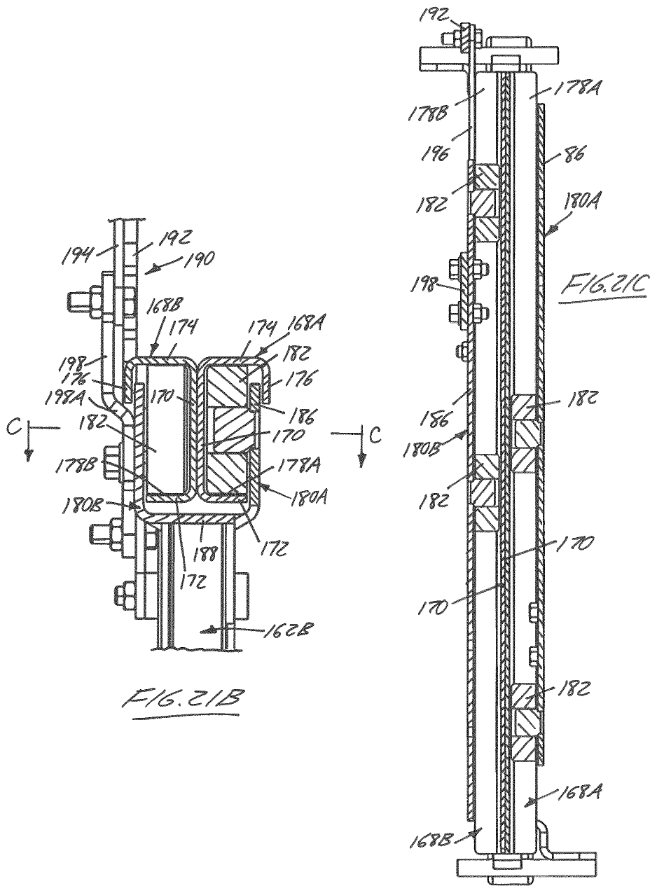

The two split doors 160A, 160B may be identical in construction and operation, and so the singular split door shown in isolation in FIGS. 19 through 21 is representative of both split doors 160A, 160B to avoid redundant illustration and description. Each split door 160A, 160B features two door panels 162A, 162B that, in the closed state of the split door 160A, reside closely side by side within the alleyway to collectively and substantially obstruct the alleyway interior at the coincident ends of the respective pair of adjacent alleyway sections. To open up this internal area of the alleyway and thereby allow livestock passage therethrough between the adjacent alleyway sections, the two door panels 162A, 162B are movable away from one another, and outwardly from the alleyway 22 via respective door slots 164A, 164B (see FIGS. 9 & 17) in the sidewall structures 20A, 20B of the alleyway 22. Such movement opens or increases a gap space between the door panels 162A, 162B to a size through which the livestock can pass in this open state of the split door 160A, 160B. In the case of the rear split door 160A, the door slot 164A, 164B in each sidewall structure 20A, 20B is delimited between the respective rear-adjacent frame post 26C, 26D at the front end of the respective livestock entrance 28A, 28B of the alleyway 22, and the nearest adjacent frame post 26E, 26F that is situated closely beside the rear-adjacent frame post 26C, 26D, which in the illustrated embodiment is the same frame post 26E, 26F at which the respective stub axle 38 and panel support shelf 142A, 142B reside. Likewise, the door slots for the front split door 160B are delimited between adjacent frame posts of the sidewall structures.

An overhead guide track 166 of the split door 160A, 160B spans internally across the alleyway 22 from one sidewall structure 20A to the other 20B immediately beneath the two headers 24 thereof to provide rollable hanging support of the two door panels 162A, 162B. Notably, this guide track 166 does not protrude outwardly beyond either sidewall structure 20A, 20B to the exterior of the alleyway 22, thus differing from the two-paneled head gate 206 at the front end 12A of the alleyway 22, whose overhead guide track instead protrudes outwardly beyond both sidewall structures 20A, 20B of the alleyway 22. Significantly, the non-protrusive guide track 166 of the rear split door 160A, whose position along the alleyway coincides with areas of the sidewall structures 20A, 20B next to which the corral panels are folded up when stowed, avoids interference with such folded.

Referring to FIGS. 19 to 21C, the guide track is composed of two metal channels 168A, 168B running across the alleyway 22 interior from beneath one header 24 to beneath the beneath the other header 24. Referring to a cross-sectional profile of each channel 168A, 168B, in planes lying longitudinally of the alleyway 22, each channel 168A, 168B has an upright vertical wall 170, a bottom wall 172 jutting horizontally from a bottom end of the upright vertical wall 170, a top wall 174 jutting horizontally from top end of the upright vertical wall 170 in the same direction as the bottom wall 172, and a flange 176 depending downwardly from a distal end of the top wall 174 furthest from the upright vertical wall 170. The flange 176 is off lesser height than the upright vertical wall 170, whereby, below the flange 176, the channel is open at the flanged side thereof. The two channels reside back-to-back with one another at their upright vertical walls 170, which thereby collectively define a divider wall, on one side of which a first rail surface 178A is defined by the topside of the bottom wall 172 of one channel 168A, and on the other side of which a second rail surface 178B is likewise defined by the topside of the bottom wall 172 of the other channel 168B.

Each door panel 162A, 162B has a respective hanger bracket 180A, 180B that is attached at a top end of the door panel, and features two rollers 182 that reside within a respective one of the guide track's two channels 168A, 168B, and thus can roll back and forth on the respective rail surface 178A, 178B at the bottom of that channel. Each hanger bracket 180A, 180B is elongated in the laterally-oriented travel direction in which the rollers 182 are rollable back and forth along the guide track 166, and possesses an L-shaped cross-sectional profile (in the same longitudinal planes in which the channel profiles were described above) over a portion of its length. An upper leg 186 of each hanger bracket's L-shaped portion stands vertically upright at the open side of the respective channel 168A, 168B beside the distal end of the bottom wall 172 thereof and just inside the flange 176, which overhangs the top edge of the hanger bracket's upper leg 186. The two rollers 182 of each hanger bracket 180A, 180B are rotatably coupled to the upper leg 186 leg thereof at an inner side side thereof facing the upright vertical wall 170 of the respective channel 168A, 168B, so that the rollers ride internally of the respective channel 168A, 168B atop the respective rail surface 178A, 178B at the bottom thereof.

Meanwhile, outside the respective channel 168A, 168B, a lower leg 188 of each hanger bracket's L-shaped cross-section projects perpendicularly and horizontally from the upper leg 186 at a bottom end thereof, and underlies the bottom walls 172 of the channels 168A, 168B. The lower leg 188 of each hanger bracket 122 is attached to the top end of the respective door panel 162A, 162B. The L-shaped portion of each hanger bracket 180A, 180B thus allows each door panel 162A, 162B to be carried directly beneath the guide track 166 on which the door panels 162A, 162B roll back and forth via their respective roller brackets 180A, 180B. The upper leg 186 of each hanger bracket 180A, 180B spans the full length thereof, which in turn spans a majority length of the guide track 166 in the split door's closed position, while the lower leg spans only the length of the respective door panel's top end. This way, the two hanger brackets 180A, 180B can roll back and forth along the shared overhead track 166 without interference by their respective lower legs 188 that ride beneath the track 166 at mutually exclusive respective halves of the track length. The portion of the bracket length over which the lower leg is absent is referred to herein as a single-leg portion of the bracket, versus the L-shaped portion having two perpendicularly divergent legs.

Each split door 160A, 160B includes a control linkage 190 installed at one side of the door, particularly at sidewall structure 20A in the illustrated example, though the linkage location may be reversed. Via this linkage, manual pulling or pushing of either one of the two door panels 162A, 162B in its opening or closing direction by a human operator will automatically move the other one of the two door panels in synchronous fashion in the same opening or closing direction. The linkage 190 includes a hammer link 192 pivotably coupled to the header 24 of the sidewall structure 20A at an outer side thereof that faces outwardly from the alleyway 22, for example via pinned connection to a pivot bracket 193 that juts from this outer side of the header 24. The linkage further includes an upper link 194 whose first end is pivotally pinned to the top end of the hammer link 192, and a lower link 196 whose first end is pivotally pinned to the bottom end of the hammer link 192. The second end of the upper link 194 is pivotally pinned to a connection bracket 198 that is bolted or otherwise affixed to the roller bracket 180B of the door panel 162B furthest from the linkage 190 at the single-leg portion thereof, which resides above the other door panel 162A in the closed position of the split door 160A, 160B. The connection bracket 198 has a bend 198A therein by which it stands upright from the roller bracket 180B in a manner angling around the flange 176 of the respective channel 168B to an elevation above the track 166, where pinned connection to the upper link 194 is made. The second end of the lower link 196 is pivotally pinned to the door panel 162A nearest to the linkage 190 at a location near an inner edge thereof that faces the far door panel 162B, at an elevation just below the track 166, and on the same side of the split door 160A, 160B at which the upper link 194 is pinned to the connection bracket 198.

Each door panel 162A, 162B has a frame composed of a bottom base member 100 and a pair of upright edge members 102, 104 standing upright therefrom, each being embodied in the illustrated example by a respective length of metal tubing. Of the upright edge members 102, 104, one is referred to an as inner edge member 102 denoting the inner edge of the door panel that faces toward the center of the alleyway and the other door panel, and the other is referred to as an outer edge member 104 denoting the outer edge of the door panel that faces outwardly from the alleyway 22. In a rectangular space framed at the bottom and sides by the bottom and edge bars 100, 102, 104 and framed at the top by the lower leg 188 of the door panel's respective hanger bracket 180A, 180B, each door panel 162A, 162B features a corrugated metal sheet 106, with an array of light-admitting apertures 108 in a top half thereof, by which light is allowed to pass through the door panel, which serves as a visual encouragement for livestock to advance toward the light, to which livestock are more naturally enticed than toward a dark alleyway space with opaque doors or gates of no light-admitting capability.

The outer edge member of each door panel 162A, 162B has two pull handles thereon in the illustrated but non-limiting embodiment, including a single-purpose pull handle 110 (e.g. D-shaped handle) of static position on the door panel 162A, 162B, and a dual-purpose pull handle 112 that is also usable to lock the split door 160A, 160B in the closed state. In the illustrated example, the dual-purpose handle comprises a handle grip 114 of generally cylindrical form, and a lock member 116 in the form of a bent metal plate of Z-shaped profile, one end portion of which is pivotally pinned to the outer edge member 104 of the door panel 162A, 162B in parallel and adjacent relationship to the outer face thereof, and the other end portion of which carries the cylindrical handle grip 114 at a distance offset outwardly from the edge member 104 and the lock member end portion pinned thereto. The dual-purpose handle 112 is pivotable about its pinned connection between a locking position and one or more unlocking positions. In the locking position, the Z-shaped profile of the locking member 116 is horizontally oriented such that the handle-carrying end portion thereof juts outwardly to a front or rear side of the door panel 162A. 162B to engage a respective lock catch 118 on an exterior of the respective sidewall structure 20A, 20B of the alleyway 22. In each unlocking position, the Z-shape profile of the locking member 116 is instead oriented in a manner disengaging from the lock catch 118, whether with the Z-shaped profile being vertically oriented along the outer edge member 104 of the door panel 162A, 162B, or horizontally oriented again, but in a position in which the handle-carrying end portion protrudes in the opposing direction away from the lock catch 118. Engagement of a dual-purpose handle 112 with its respective lock catch can be seen in FIG. 17, where lock catch 118 is affixed to the frame post 26E at the front side of the door slot 164B. FIG. 9 shows the dual-purpose handle 112 on the other door panel of the same split door 160A at the opposing side of the alleyway in its unlocking position disengaged from the lock catch 118 affixed to the matching frame post 26F.

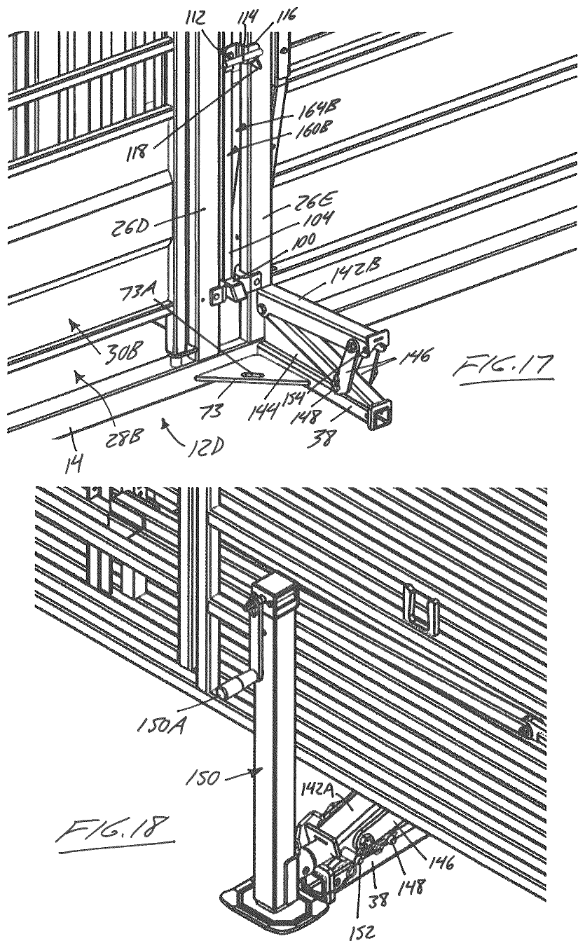

With reference to the closed state of the split door 160A, 160B of FIG. 20, when both dual-purpose handles 112 are in their unlocking positions, manually pulling on handle 110 or 112 of the right door panel 162B will slide this right door panel outwardly from the alleyway 22 through the respective door slot 164B in the right sidewall structure 20B of the alleyway 22. Since upper link 194 of linkage 190 is attached to the hanger bracket 180B of the right door panel 162B, this pulling of right door panel 162B will pull on the top end of the hammer link 192, rotating the hammer link 192 clockwise about its pinned connection to the pivot bracket 193 that is affixed to the header of the left sidewall structure 20A of the alleyway 22. The hammer link 192 in turn pulls the bottom link 196 of the linkage 190 leftward, thereby sliding the left door panel 162A outwardly from the alleyway 22 through the respective door slot 164A in the left sidewall structure 20A of the alleyway, in synchronous fashion to the directly handle-actuated rightward movement of the right door panel 162B, thereby opening the split door 160A, 160B. From this open state of the split door 160A, 160B, manually pushing either handle 110, 112 of the right door panel 162B leftward will have the reverse effect, pushing the top end of the hammer link 192 leftward to drive counter-clockwise rotation of this link, thereby driving its lower end and the attached lower link rightward to push the left door panel 162A closed in synchronous relation to the directly handle-actuated leftward closure of the right door panel 162B.

The same manual actuation of the split door is possible from the opposing side of the alleyway 22. Referring again to the closed state of the split door 160A, 160B of FIG. 20, when both dual-purpose handles 112 are in their unlocking positions, manually pulling on handle 110 or 112 of the left door panel 162A will slide this left door panel outwardly from the alleyway 22 through the respective door slot 164A in the left sidewall structure 20A of the alleyway 22. Since lower link 196 is attached to the left door panel 162A, this pulling of the left door panel 162A will push the bottom end of the hammer link 192 outwardly, rotating the hammer link 192 clockwise about its pinned connection, which in turn pushes the upper link 194 rightward, thereby driving rightward rolling of the left door panel's hanger bracket 180B and thus sliding the right door panel outwardly from the alleyway 22 through the respective door slot 164B in the right sidewall structure 20B of the alleyway, in synchronous fashion to the directly handle-actuated leftward movement of the left door panel 162A, thereby opening the split door 160A, 160B. From this open state of the split door 160A, 160B, manually pushing either handle 110, 112 of the left door panel 162A rightward will have the reverse effect, pulling the bottom end of the hammer link 192 rightward to drive counter-clockwise rotation of this link 192, thereby driving its upper end and the attached upper link 194 leftward, which pulls the hanger bracket 180B of the right door panel 162B leftward, thereby closing the right door panel 162B in synchronous relation to the directly handle-actuated rightward closure of the left door panel 162A.

Referring to FIGS. 1 to 4, at the squeeze section 22B, a pair of movable squeeze panels 200A, 200B each normally reside in a non-working position situated generally within a vertical plane bound by the longitudinal beam 14 and overlying header 124 of a respective one of the sidewall structures 20A, 20B between a front frame post 26G, 26H of that sidewall structure and a rearwardly nearest front-adjacent frame post 26I, 26J thereof. A control linkage 202 is operable by way of a squeeze control lever 204 installed externally on one side of the squeeze section 22B near a head gate 206 thereof that is installed at the front end of the alleyway 22 at a livestock exit opening thereof bound between the two front frame posts 26G, 26H that stand upright at or near the corners of the frame 12 wherein the longitudinal beams 14 meet the front cross-beam 16. As is well known in the art, departure of an individually admitted animal through the livestock exit opening at the front end of the squeeze is controlled via the head gate 206, two movable gate panels of which, in a closed state of head gate 206, abut against opposing sides of the animal's body, with the animal's head outside the chute, but the trailing remainder of their body is still inside the chute. By manipulation of the squeeze control lever 204, and via the control linkage actuated thereby, the two squeeze panels 200A, 200B are similarly selectively movable in an inward direction toward one another and into the interior space of the alleyway section 22B in order to constrict the width of the interior space and thereby squeeze against opposing sides of this trailing part of the animal's body, thus cooperating with the head gate 206 to substantively constrain the animal in a stationary position for safe inspection and/or treatment thereof by a human operator from laterally outside the chute, or inside the chute at a veterinary cage thereof that resides behind the held animal, as enabled by the illustrated inclusion of cage panels 208A, 208B that are carried by, and form respective extensions of, the squeeze panels 200A, 200B.

In the illustrated embodiment, the functional squeeze chute and associated head gate 206 embodied in the front squeeze section of the alleyway 22 is of the type disclosed in Applicant's Published US Patent Application 2022/0272939 (national phase of WO2021/097549), which includes the illustrated needle access side gates 209A, 209B disclosed in Applicant's Published US Patent Application 2022/0287266 (national phase of WO2021/081618), all of which are incorporated herein by reference in their entirety, though the sliding gate at the rear entrance of the previously published squeeze chute design is replaced with the novel front split door in the presently illustrated embodiment. Using this design from Applicant's prior publications, the head gate 206 at the front end of the alleyway is operable at any location along the side of the squeeze section via a headgate operating handle 210 that is slidable back and forth along a drive shaft 212 that spans a substantially full length of the squeeze section 22B alongside the header 24 of the respective sidewall structure 20A. That being said, any variety of known squeeze chute and head gate designs capable of comparable function may alternatively be used at the squeeze section 22B of the alleyway, without detriment various aspects disclosed herein concerning incorporation of a fully functional squeeze into a portable corral, which equipment Applicant has not heretofore seen combined in any manner.

Referring to FIGS. 8 and 9, the intermediate section 22C of the alleyway may be configured with adjustable sidewall panels 214A, 214B each contained in the sidewall space bound between an adjacent pair of frame posts of the respective wall structure, for example between the frame posts 26E, 26F that define the front boundaries of the door slots 164A, 164B of the rear split door 160A and a pair of frame posts 26K, 26L that define the rear boundaries of the of the door slots 164A, 164B of the front split door 160B, and from which the front pair of offset support posts 48C, 48D are offset outwardly from the headers 24 and underlying beams 14 of the sidewall structures 20A, 20B and frame 12. The sidewall panels 214A, 214B are adjustable in position to adjust the effective internal width of intermediate alleyway section 22C, as measured between the two opposing sidewall panels 214A, 214B. In the illustrated example, these adjustable sidewall panels 214A, 214B are of type disclosed in Applicant's Published US Patent Application 2022/0312720 (national phase of WO2021/016698), the entirety of which is also incorporated herein by reference, whereby the bottom of each adjustable sidewall panel 214A, 214B is pivotally supported at both ends for pivotal movement of the sidewall panel about a longitudinally oriented pivot axis, and the top of the panel has extendable/retractable lock pins 216 at both ends thereof that are selectively engageable in different panel support holes provided in a pair of cross-headers 218 that span laterally between the longitudinal headers 24 at the ends of the intermediate section 22B. Temporary release of the lock pins 216 at both ends of either sidewall panel 214A, 214B from the two cross-headers 218 enables tilting of the top end of the sidewall panel 214A, 214B inwardly or outwardly toward or away from the longitudinal mid-plane of the alleyway 22 about the longitudinal pivot axis of the panel's bottom end. This adjusts the effective width of the alleyway 22 between the two sidewall panels 214A, 214B, which can be locked by re-engagement of the locking pins 216 into a selected pair of the panel support holes in the cross-headers 218. In other embodiments, the intermediate alleyway section 22C may employ another style of adjustable sidewall panels for control over the effective width of this alleyway section, or may employ fixed sidewall panels with no ability to adjust the effective alleyway width.

It will be appreciated that several of the novel and inventive aspects of the apparatus may be employed in combination, as evidenced by the illustrated embodiment that encompasses all such aspects, but also may be put to use in other embodiments where any one or more such aspects are omitted or isolated from on another. For example, aspects specifically related to the corral panels, weight-bearing support thereof, and multi-axis hinge arrangements therefor may be also be implemented in various corral apparatuses with or without a central alleyway or integrated livestock squeeze.

Since various modifications can be made in my invention as herein above described, and many apparently widely different embodiments of same made, it is intended that all matter contained in the accompanying specification shall be interpreted as illustrative only and not in a limiting sense.

1. A portable livestock corral apparatus comprising:
a towable frame of elongated character in a longitudinal direction, and having first and second sides of opposing relation to one another in a lateral direction of transverse relation to said longitudinal direction;
first and second sidewall structures of erect relationship to said towable frame at the first and second sides thereof, respectively, and thereby respectively denoting first and second sides of a longitudinally oriented alleyway that is delimited between said first and second sidewall structures and has front and rear ends of opposing relationship to one another in said longitudinal direction;
a first set of corral panels foldable into a stowed condition folded up alongside the first sidewall structure outside the alleyway at the first side thereof, and unfoldable to a deployed state reaching further outward from the first sidewall structure to delimit a first livestock pen at the first side of the alleyway, from which the livestock are admissible to the alleyway through a first livestock entranceway that opens into said alleyway from said first livestock pen; and
a functional livestock squeeze comprising a cooperating pair of first and second squeeze panels operably installed in the first and second sidewall structures at a squeeze section of the alleyway that, in the longitudinal direction of the alleyway, resides between the first livestock entranceway and a livestock exit at the front end of the alleyway.

2. The apparatus of claim 1 wherein said first set of corral panels comprises a front corral panel of movably coupled relationship to the first sidewall structure of the alleyway at a location situated longitudinally between the first livestock entrance and the squeeze section.

3. The apparatus of claim 1 or 2 wherein the location at which the front corral panel of the first set is movably coupled to the first sidewall structure is nearer to the squeeze section than to the first livestock entranceway.

4. The apparatus of any preceding claim wherein the first livestock entranceway is nearer to the rear end of the alleyway than to the front end thereof.

5. The apparatus of any preceding claim wherein the alleyway spans at least a majority length of the towable frame in the longitudinal direction.

6. The apparatus of any preceding claim wherein the alleyway spans a substantial entirety of the towable frame in the longitudinal direction.

7. The apparatus of any preceding claim wherein the alleyway includes both an entrance section at which the first livestock entranceway resides, and an intermediate section alleyway that, in the longitudinal direction, resides between the squeeze section and an entrance section.

8. The apparatus of claim 7 wherein the intermediate section of the alleyway is characterized by at least one adjustable alleyway sidewall panel of movable relation toward and away from an opposing alleyway sidewall panel to adjust a working width of the alleyway at said intermediate section.

9. The apparatus of any preceding claim wherein the first set of corral panels further comprises a rear corral panel of movably coupled relationship to the first sidewall structure of the alleyway at a location that is situated across the first livestock entranceway from the front corral panel of the first set, and also nearer to the rear end of the alleyway than the front corral panel of the first set.

10. The apparatus of claim 9 wherein the front and rear corral panels are of the same construction and same reversible configuration as one another, each comprise an openable/closable man gate that is closer to a first end of the respective corral panel than to an opposing second thereof, and are installed in opposing orientation to one another such that the first end of the front corral panel is movably coupled to the first sidewall structure of the alleyway and the second end of the rear corral panel is movably coupled to the first sidewall structure of the alleyway, whereby in a deployed state of the first set of corral panels delimiting the first livestock pen, the openable/closable man gate of the front corral panel is closer to the alleyway than the openable/closable man gate of the rear corral panel.

11. The apparatus of any preceding claim wherein the towable frame is configured for hitched connection to a tow vehicle at a towing end of the frame that is of nearer relationship to the front end of the alleyway than to the rear end thereof.

12. The apparatus of any preceding claim further comprising a second set of corral panels deployable externally of the alleyway outside the second sidewall structure thereof to cooperatively delimit a second livestock pen situated across the alleyway from the first livestock pen, and from which the livestock are admissible to the alleyway through a second livestock entranceway that opens into said alleyway from said second livestock pen.

13. The apparatus of claim 12 wherein the second set of corral panels are of matching setup to the first set of corral panels.

14. The apparatus of claim 12 or 13 further comprising a set of bud box panels deployable in a working configuration situated externally of the alleyway outside the first sidewall structure thereof in a position across from the second livestock entranceway to create an enclosed bud box for use routing of the livestock from the second livestock pen into the alleyway via the second livestock entranceway.

15. The apparatus of claim 14 wherein the set of bud box panels comprises a swingable bud box panel that is swingable relative to the alleyway between a stowed position running alongside the alleyway, and a deployed position spanning laterally outward therefrom for establishment of said working configuration.

16. The apparatus of claim 15 wherein the set of bud box panels comprises a bud box gate panel that, at a first end thereof, is hinged to the swingable bud box panel for swinging movement between a folded position folded up alongside the swingable bud box panel and an unfolded position spanning outward therefrom for coupling to one of the corral panels of the first set, at a second end of said bud box gate panel, thereby establishing said working configuration of the set of bud box panels.

17. The apparatus of claim 16 wherein the bud box gate panel and said one of the corral panels are couplable by a latch bar that, in a latching position thereof, engages first and second brackets respectively found on the gate panel and said one of the corral panels, between which the latch bar is movably coupled to the bud box gate panel by a multi-axis pivot joint, about a first axis of which a handle portion of the latch bar is liftable off the first bracket, then swingable about a second axis of said multi-axis pivot joint off to one side of said first bracket, then lowerable about said first axis to raise a latching portion of said latch bar from the second bracket.

18. The apparatus of claim 16 or 17 wherein the gate panel is a frameless gate panel, and the set of bud box panels further comprises a joiner bar that, at a first end thereof, is also hinged to the swingable bud box panel, but independently of the gate panel, for swinging movement relative to the swingable bud box panel at a greater elevation thereon than said gate panel, between a likewise folded position running along the swingable bud box panel and a likewise unfolded position spanning outward therefrom for coupling to the first set of corral panels to fix a position of the swingable bud box gate in the working configuration of the set of bud box panels.

19. The apparatus of any preceding claim comprising at least one split door installed in the alleyway that is selectively movable between an open state permitting passage of livestock from one section of the alleyway to another, and a closed state preventing said passage, said split gate comprising two door panels that reside side by side to collectively and substantially obstruct the alleyway in said closed state, and that are movable apart from one another to open or increase a gap therebetween through which the livestock can pass in said open state, wherein a guide track on which said door panels ride during movement thereof between said open and closed states is of substantially non-protruding relation beyond either sidewall structure of the alleyway.

20. The apparatus of any preceding claim wherein at least one corral panel among the first set of corral panels has a hinged end at which a multi-axis hinge arrangement joins said corral panel to a neighbouring component of the apparatus, and is characterized by an upright swing axis about which the corral panel is swingable side-to-side, and a transverse tilt axis that lies transversely of both the corral panel and the swing axis and about which the corral panel is tiltable up and down.

21. A livestock corral apparatus comprising at least one set of corral panels foldable between a stowed condition folded up alongside one another, and a deployed condition unfolded from one another to cooperatively delimit a livestock pen, wherein at least one corral panel among the set of corral panels has a hinged end at which a multi-axis hinge arrangement joins said corral panel to a neighbouring component of the apparatus, and is characterized by an upright swing axis about which the corral panel is swingable side-to-side, and a transverse tilt axis that lies transversely of both the corral panel and the swing axis and about which the corral panel is tiltable up and down.

22. The apparatus of claim 20 or 21 wherein the multi-axis hinge arrangement comprises one or more post brackets through which an upright end post of the corral panel extends in a manner tiltable back and forth therein, and that are swingable relative to said neighbouring component about the upright swing axis.

23. The apparatus of claim 22 wherein the multi-axis hinge arrangement comprises one or more upright hinge pins by which the one or more post brackets are pinned to the neighbouring component on said upright swing axis.

24. The apparatus of claim 23 wherein the one or more upright hinge pins pin the one or more post brackets to the neighbouring component at hinge brackets that project from an upright post of the neighbouring component to offset said upright swing axis from said upright post of the neighbouring component.

25. The apparatus of any one of claims 22 to 24 wherein the multi-axis hinge arrangement comprises a transverse hinge pin that penetrates one of the one or more post brackets, and in doing so, also penetrates a portion of the corral panel received within said one of the one or more post brackets.

26. The apparatus of any one of claims 22 to 25 wherein at least one of the one or more post brackets is channel-shaped.

27. The apparatus of any one of claims 23 to 26 wherein a stop pin penetrates opposing side walls of a channel-shaped one of the one or more post brackets at a position lying across the end post of the corral panel from the neighbouring component.

28. The apparatus of any one of claims 22 to 27 wherein the one or more post brackets comprise two post brackets at spaced elevations from one another along the upright end post of the corral panel.

29. The apparatus of claim 28 wherein said two post brackets have two respective cross-pins engaged respectively thereto, of which one of said respective cross-pins penetrates a portion of the corral panel to define the tilt axis about which the corral panel is tiltable, and the other of said respective cross-pins lies across the end post of the corral panel from the neighbouring component.

30. The apparatus of claim 29 wherein said two post brackets are identical, and the respective cross-pins reside at matching positions on said two identical post brackets.

31. A livestock corral apparatus comprising:
an alleyway having first and second erectly standing sidewall structures at opposing first and second sides of the alleyway, respectively;
a first set of corral panels foldable into a stowed condition folded up alongside the first sidewall structure outside the alleyway at the first side thereof, and unfoldable to a deployed state reaching further outward from the first sidewall structure to delimit a first livestock pen outside the alleyway at the first side thereof;
a second set of corral panels foldable into a stowed condition folded up alongside the second sidewall structure outside the alleyway at the second side thereof, and unfoldable to a deployed state reaching further outward from the second sidewall structure to delimit a second livestock pen outside the alleyway at the second side thereof; and
at least one split door installed in the alleyway that is selectively movable between an open state permitting passage of livestock from one section of the alleyway to another, and a closed state preventing said passage, said split gate comprising two door panels that reside side by side to collectively and substantially obstruct the alleyway in said closed state, and that are movable apart from one another to open or increase a gap therebetween through which the livestock can pass in said open state;
wherein a guide track on which said door panels ride during movement thereof between said open and closed states spans between the first and second sidewall structures at areas thereof outside of which the first and second sets of corral panels reside when stowed, and is of substantially non-protruding relation beyond either sidewall structure of the alleyway.

32. The apparatus of claim 19 or 31 wherein the two door panels are interconnected by a linkage by which manual outward pulling of either door panel is operable to automatically open the other door panel.

33. The apparatus of claim 32 wherein each door panel is equipped with at least one pull handle that is coupled thereto independently of said linkage.

34. The apparatus of claim 33 wherein said at least one pull handle comprises a dual-purpose pull handle attached to pivotal lock member that, via manipulation of said dual purpose pull handle, is pivotable between a locked position engaged with a lock catch to block movement of the door panel, and an unlocked position withdrawn from the lock catch to allow said movement of the door panel.

35. The apparatus of claim 34 wherein said at least one pull handle also comprises a non-locking pull handle.

36. The apparatus of claim 19 wherein said at least one split door comprises a split door installed at the squeeze section to control livestock entry thereto.

37. The apparatus of claim 36 wherein said at least one split door further comprises another split door located at a spaced distance rearwardly from the first split door and nearer to the first livestock entrance to control livestock entry to an intermediate alleyway space delimited between said split doors.

38. The apparatus of any one of claims 1 to 20 and 31 to 37 further comprising a first panel-support shelf projecting laterally outward from the first sidewall structure at a location that underlies at least a subset of the first set of corral panels when folded up and stowed alongside the first sidewall structure, said first panel-support shelf being raiseable and lowerable between a raised position of supportive abutment against undersides of said subset of corral panels, when stowed, to at least partially bear a weight thereof, and a lowered position withdrawn from the undersides of said subset of corral panels.

39. A portable livestock corral apparatus comprising:
a towable frame of elongated character in a longitudinal direction, and having first and second sides of opposing relation to one another in a lateral direction of transverse relation to said longitudinal direction;
at least one set of corral panels foldable into a stowed condition folded up along a respective side of the towable frame, and unfoldable to a deployed state reaching further outward from the respective of the towable frame to delimit a respective livestock pen;
at least one panel-support shelf projecting laterally outward from a respective side of the towable frame at a location that underlies at least a subset of the corral panels when folded up in the stowed condition alongside the towable frame, said panel-support shelf being raiseable and lowerable between a raised position of supportive abutment against undersides of said subset of corral panels, when stowed, to at least partially bear a weight thereof, and a lowered position withdrawn from the undersides of said subset of corral panels.

40. The apparatus of claim 38 or 39 wherein the panel-support shelf is raisable and lowerable about a pivot point.

41. The apparatus of any one of claims 39 to 40 comprising a mechanical lock operable to lock the panel shelf in the raised position.

42. The apparatus of claim 41 wherein the mechanical lock comprises one or more locking lugs attached to one of either the panel shelf or an underlying shelf base situated therebelow, and selectively lockable to the other thereof in the raised position of the panel shelf to form one or more supportive struts spanning from the base to the raised panel shelf.

43. The apparatus of claim 42 wherein the one or more locking lugs comprises a pair of locking lugs are situated on opposing sides of the panel shelf and the underlying shelf base and engageable by a singular lock pin passed through the panel shelf and the underlying shelf base.

44. The apparatus of claim 42 or 43 wherein the one or more locking lugs are pivotally coupled to the panel shelf, and arranged to lie longitudinally alongside the panel shelf in the lowered position thereof, and swing downward therefrom into a hanging position reaching downwardly toward the shelf base during raising of the panel shelf into the raised position.

45. The apparatus of any one of claims 38 to 44 comprising a lifting jack selectively engageable to the panel shelf and operable, when so engaged, to raise the panel shelf from the lowered position to the raised position.

46. The apparatus of any one of claims 1 to 20 wherein the first set of corral panels are configured for selective deployment thereof in at least two different states of deployment, including a side pen state in which said first set of panels delimit only said first livestock pen at said first side of the alleyway, and a side and rear pen state in which said first set of panels both delimit said first livestock pen and also at least partially delimit a rear livestock pen situated behind the rear end of the alleyway.

47. A portable livestock corral comprising:
a towable frame of elongated character in a longitudinal direction, and having first and second sides of opposing relation to one another in a lateral direction of transverse relation to said longitudinal direction; and
a first set of corral panels foldable into a stowed condition folded up along a respective side of the towable frame, and unfoldable to a deployed state reaching further outward from the respective of the towable frame to delimit a first livestock pen at the first side of said towable frame;
wherein the first set of corral panels are configured for selective deployment thereof in at least two different states of deployment, including a side pen state in which said first set of panels delimit only said first livestock pen at said first side of the alleyway, and a side and rear pen state in which said first set of panels both delimit said first livestock pen and also at least partially delimit a rear livestock pen situated behind the rear end of the towable frame.

48. The apparatus of claim 46 wherein:
the first set of corral panels comprise a front subset of panels of hinged connection to one another, and to which the front corral panel belongs, and a rear subset of panels of hinged connection to one another, among which there is included a rear corral panel of movably coupled relationship to the first sidewall structure at a location nearer to the rear end of the towable frame than the front corral panel;
the front and rear subsets, in the side pen state, both span laterally outward from the first sidewall structure, with respective end panels of the front and rear subsets reside adjacent one another for coupling together thereof such that the front and rear subsets collectively delimit the first livestock pen at the first side of the alleyway, in which instance the first livestock pen is of a first size; and
in the side and rear pen state, the front subset, starting from the front corral panel, first spans laterally outward from the first side wall structure before turning rearwardly and back inwardly back toward the first sidewall structure to place the respective end panel of the front subset adjacent to the rear corral panel, which likewise spans laterally out from the first sidewall structure, for coupling together of the respective end panel of the front subset with the rear corral panel such that the front subset and the rear corral panel collectively delimit the first livestock pen, at a smaller second size, while a remainder of the rear subset is deployed rearwardly from the rear corral panel and beyond the rear end of the towable frame to at least partially delimit the rear livestock pen, in a manner separated from the first livestock pen by the rear corral panel.

49. The apparatus of claim 47 wherein:
said first set of corral panels include front and rear corral panels movably coupled to the towable frame via hinged supports, of which the front corral panel is movably coupled to the towable frame nearer to the front end thereof than the rear corral panel, and the rear corral panel is movably coupled to the towable frame nearer to the rear end thereof than the front corral panel;
said first set of corral panels comprise:
a front subset of panels of hinged connection to one another, and to which the front corral panel belongs; and
a rear subset of panels of hinged connection to one another, and to which the rear panel belongs;
the front and rear subsets, in the side pen state, both span laterally outward from the first side of the towable frame, with respective end panels of the front and rear subsets residing adjacent one another for coupling together thereof such that the front and rear subsets collectively delimit the first livestock pen at the first side of the towable frame, in which instance the first livestock pen is of a first size; and
in the side and rear pen state, the front subset, starting from the front corral panel, first spans laterally outward from the first side wall structure before turning rearwardly and inwardly back toward the towable frame to place the respective end panel of the front subset adjacent to the rear corral panel, which likewise spans laterally out from the first side of the towable frame, for coupling together of the respective end panel of the front subset with the rear corral panel such that the front subset and the rear corral panel collectively delimit the first livestock pen, but at a smaller second size, while a remainder of the rear subset is deployed rearwardly from the rear corral panel and beyond the rear end of the towable frame to at least partially delimit the rear livestock pen, in a manner separated from the first livestock pen by the rear corral panel.

50. The apparatus of claim 48 or 49 wherein the rear corral panel has an openable/closeable first-pen man gate therein by which a human operator can traverse between the first livestock pen and the rear livestock pen.

51. The apparatus of any one of claims 48 to 50 wherein the respective end panel of the rear subset, in the side and rear pen state, is couplable to the towable frame at the rear end thereof.

52. The apparatus of claim 51 wherein the respective end panel of the rear subset, side and rear pen state, is couplable to the towable rear frame at the second side thereof, and thus across the rear end of the towable frame from where the rear corral panel is movably coupled thereto.

53. The apparatus of any one of claims 46 to 52 comprising a rear alleyway gate at the rear end of the towable frame that is openable and closable to permit and prevent passage therethrough from the rear livestock pen.

54. The apparatus of any one of claims 46 to 53 comprising a second set of corral panels foldable into a stowed condition folded up along the second side of the towable frame, and unfoldable to a deployed state reaching further outward from the second of the towable frame to delimit a second livestock pen on the second side of the towable frame.

55. The apparatus of claim 54 wherein the second set of corral panels are configured for selective deployment thereof in at least a large side pen state in which said second livestock pen has a size that exceeds the first livestock pen in the side and rear state of the first set of corral panels.

56. The apparatus of claim 55 wherein a full quantity of said second set of corral panels delimit the second livestock pen in said large side pen state.

57. The apparatus of any one of claims 54 to 56 wherein one of the corral panels of the first set, in the side and rear pen state thereof, is couplable to one of the corral panels of the second set, such that the first and second sets of corral panels cooperatively delimit the rear livestock pen.

58. The apparatus of claim 57 comprising an openable/closable second-pen man gate that is positioned to communicate the second livestock pen with the rear livestock pen when said one of the corral panels of the first set is coupled to said one of the corral panels of the second set.

59. The apparatus of claim 57 or 58 wherein said one of the corral panels of the first set is selectively couplable to different corral panels among the second set.

60. The apparatus of any one of claims 54 to 59 wherein the second set of corral panels are configured for selective deployment thereof in at least a reduced side pen state in which said second livestock pen has a size less than the first livestock pen in the side pen state thereof.

61. The apparatus of any one of claims 48 to 52 comprising a second set of corral panels foldable into a stowed condition folded up along the second side of the towable frame, said second set of corral panels including a second front corral panel and second rear corral panel movably coupled to the towable frame via additional hinged supports, of which the second front corral panel is movably coupled to the towable frame nearer to the front end thereof than the second rear corral panel, and the second rear corral panel is movably coupled to the towable frame nearer to the rear end thereof than the second front corral panel;
wherein:
said second set of corral panels comprise:
a second front subset of panels of hinged connection to one another, and to which the second front corral panel belongs; and
a second rear subset of panels of hinged connection to one another, and to which the second rear panel belongs;
the second front and second rear subsets are deployable from the stowed condition into another side-pen state both spanning laterally outward from the second side of the towable frame, and in which respective end panels of the second front and second rear subsets reside adjacent one another and are couplable together such that the second front and second rear subsets collectively delimit the second livestock pen at the second side of towable frame; and
the second front and second rear subsets are also deployable from the stowed condition into another side and rear pen state, in which the second front subset, starting from the second front corral panel, first spans laterally outward from the second side of the towable frame before turning rearwardly and back inwardly toward the towable frame to place the respective end panel of the second front subset adjacent to the second rear corral panel, which likewise spans laterally out from the second side of the towable frame, and from which a remainder of the second rear subset is deployed rearwardly and connects to the rear subset of the first set of corral panels to cooperatively delimit the rear livestock pen therewith.

62. A portable livestock corral comprising:
a towable frame of elongated character in a longitudinal direction, said towable frame having two ends of opposing relation to one another in said longitudinal direction, and first and second sides of opposing relation to one another in a lateral direction of transverse relation to said longitudinal direction;
first and second sidewall structures of erect relationship to said towable frame at the first and second sides thereof, respectively, and thereby respectively denoting first and second sides of a longitudinally oriented alleyway delimited between said first and second sidewall structures;
a first livestock entrance in the first sidewall structure, through which livestock are selectively admissible into the alleyway from the first side thereof;
a second livestock entrance in the second sidewall structure, through which livestock are selectively admissible into the alleyway from the second side thereof;
a first set of foldable corral panels deployable externally of the alleyway outside the first sidewall structure thereof to cooperatively delimit a first livestock side pen from which the livestock are admissible to the alleyway through said first livestock entrance;
a second set of foldable corral panels deployable externally of the alleyway outside the second sidewall structure thereof to cooperatively delimit a second livestock side pen residing across the alleyway from said first livestock side pen, and from which the livestock are admissible to the alleyway through said second livestock entrance; and
a set of foldable bud box panels deployable in a first working position outside the alleyway at the first side thereof in a position across from the second livestock entrance to create an enclosed bud box for use in routing of the livestock from the second livestock side pen into the alleyway.

63. The apparatus of claim 62 wherein the set of bud box panels comprises a swingable bud box panel that is swingable relative to the alleyway between a stowed position running alongside the alleyway, and a deployed position spanning laterally outward therefrom for establishment of said working configuration.

64. The apparatus of claim 63 wherein the set of bud box panels comprises a bud box gate panel that, at a first end thereof, is hinged to the swingable bud box panel for swinging movement between a folded position folded up alongside the swingable bud box panel and an unfolded position spanning outward therefrom for coupling to one of the corral panels of the first set, at a second end of said bud box gate panel, thereby establishing said working configuration of the set of bud box panels.

65. The apparatus of claim 64 wherein the bud box gate panel and said one of the corral panels are couplable by a latch bar that, in a latching position thereof, engages first and second brackets respectively found on the gate panel and said one of the corral panels, between which the latch bar is movably coupled to the bud box gate panel by a multi-axis pivot joint, about a first axis of which a handle portion of the latch bar is liftable off the first bracket, then swingable about a second axis of said multi-axis pivot joint off to one side of said first bracket, then lowerable about said first axis to raise a latching portion of said latch bar from the second bracket.

66. The apparatus of claim 64 or 65 wherein the gate panel is a frameless gate panel, and the set of bud box panels further comprises a joiner bar that, at a first end thereof, is also hinged to the swingable bud box panel, but independently of the gate panel, for swinging movement relative to the swingable bud box panel at a greater elevation thereon than said gate panel, between a likewise folded position running along the swingable bud box panel and a likewise unfolded position spanning outward therefrom for coupling to the first set of corral panels to fix a position of the swingable bud box gate in the working configuration of the set of bud box panels.
